(19) United States
(12) Patent Application Publication
(10) Pub. No.: US 2026/0352293 A1
(43) Pub. Date: Nov. 5, 2026

(54) PROCESSING OF CSI FOR UE-INITIATED REPORTING

(71) Applicant: Samsung Electronics Co., Ltd., Suwon-si (KR)

(72) Inventors: Dalin Zhu, Allen, TX (US); Eko Onggosanusi, Coppell, TX (US)

(21) Appl. No.: 19/636,566

(22) Filed: Apr. 1, 2026

Related U.S. Application Data
(60) Provisional application No. 63/800,190, filed on May 5, 2025.
(60) Provisional application No. 63/801,608, filed on May 7, 2025.

(51) Int. Cl. H04B 7/06; H04L 5/00; H04W 24/10

(52) U.S. Cl. CPC H04B 7/0626; H04L 5/0044; H04W 24/10

(57) ABSTRACT

Apparatuses and methods for processing of channel state information (CSI) for user equipment (UE)-initiated reporting. A method performed by a user equipment includes receiving information related to a UE-initiated report (UEIR); determining, based on the information, an uplink slot for transmitting the UEIR; and determining, based on the information and the uplink slot, a reference slot for a CSI reference resource. The information indicates a transmission mode. The method further includes determining, based on the CSI reference resource, one or more transmission occasions (TOs) of one or more reference signals (RSs); determining the UEIR based on a subset of the one or more TOs; and transmitting the UEIR. The one or more TOs are associated with determining an event or reporting measurements.

### CROSS-REFERENCE TO RELATED AND CLAIM OF PRIORITY

The present application claims priority under 35 U.S.C. § 119(e) to U.S. Provisional Patent Application No. 63/800,190 filed on May 5, 2025 and U.S. Provisional Patent Application No. 63/801,608 filed on May 7, 2025, which are hereby incorporated by reference in their entirety.

### TECHNICAL FIELD

The present disclosure relates generally to wireless communication systems and, more specifically, the present disclosure is related to processing of channel state information (CSI) for user equipment (UE)-initiated reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to processing of CSI for UE-initiated reporting.

In one embodiment, a UE is provided. The UE includes a transceiver configured to receive information related to a UE-initiated report (UEIR). The information indicates a transmission mode. The UE further includes a processor operably coupled with the transceiver. The processor is configured to determine, based on the information, an uplink slot for transmitting the UEIR; determine, based on the information and the uplink slot, a reference slot for a CSI reference resource; determine, based on the CSI reference resource, one or more transmission occasions (TOs) of one or more reference signals (RSs); and determine the UEIR based on a subset of the one or more TOs. The one or more TOs are associated with determining an event or reporting measurements. The transceiver is further configured to transmit the UEIR.

In another embodiment, a base station (BS) is provided. The BS includes a transceiver configured to transmit information related to a UEIR. The information indicates a transmission mode. The BS further includes a processor operably coupled with the transceiver. The processor is configured to determine, based on the information, an uplink slot for transmitting the UEIR; determine, based on the information and the uplink slot, a reference slot for a CSI reference resource; determine, based on the CSI reference resource, one or more TOs of one or more RSs; and determine the UEIR based on a subset of the one or more TOs. The one or more TOs are associated with determination of an event or reporting of measurements. The transceiver is further configured to receive the UEIR.

In yet another embodiment, a method performed by a UE is provided. The method includes receiving information related to a UEIR; determining, based on the information, an uplink slot for transmitting the UEIR; and determining, based on the information and the uplink slot, a reference slot for a CSI reference resource. The information indicates a transmission mode. The method further includes determining, based on the CSI reference resource, one or more TOs of one or more RSs; determining the UEIR based on a subset of the one or more TOs; and transmitting the UEIR. The one or more TOs are associated with determining an event or reporting measurements.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example beam operation in a wireless communication system according to embodiments of the present disclosure;

FIG. 5B illustrates an example multi-beam operation in a wireless communication system according to embodiments of the present disclosure;

FIG. 6 illustrates an example of a transmitter structure for beamforming according to embodiments of the present disclosure; and

FIG. 7 illustrates an example method performed by a UE in a wireless communication system according to embodiments of the present disclosure.

### DETAILED DESCRIPTION

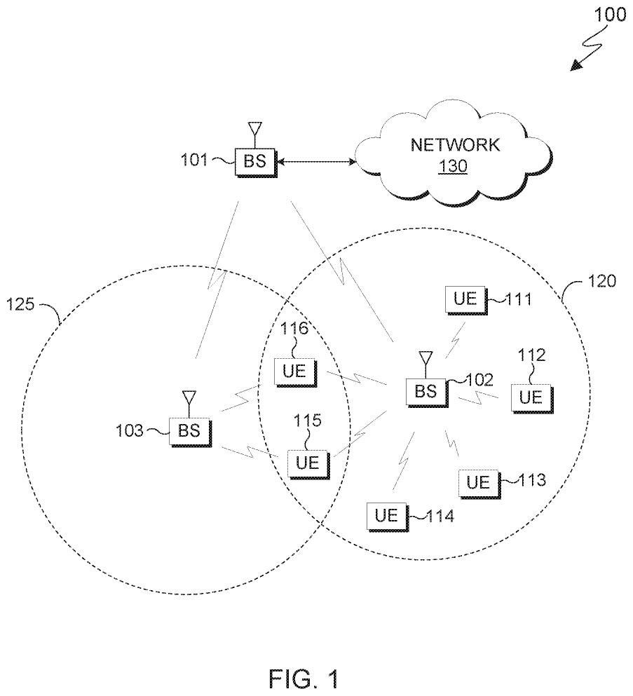

FIGS. 1-7 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211 v16.1.0, “NR; Physical channels and modulation” (herein, “REF 1”); 3GPP TS 38.212 v16.1.0, “NR; Multiplexing and Channel coding” (herein, “REF 2”); 3GPP TS 38.213 v16.1.0, “NR; Physical Layer Procedures for Control” (herein, “REF 3”); 3GPP TS 38.214 v16.1.0, “NR; Physical Layer Procedures for Data” (herein, “REF 4”); 3GPP TS 38.321 v16.1.0, “NR; Medium Access Control (MAC) protocol specification” (herein, “REF 5”); and 3GPP TS 38.331 v16.1.0, “NR; Radio Resource Control (RRC) Protocol Specification” (herein, “REF 6”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101 (e.g., base station, eNB, gNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for supporting UE-initiated reporting of CSI. In certain embodiments, one or more of the BSs 101-103 include circuitry, programing, or a combination thereof to support processing of CSI for UE-initiated reporting.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

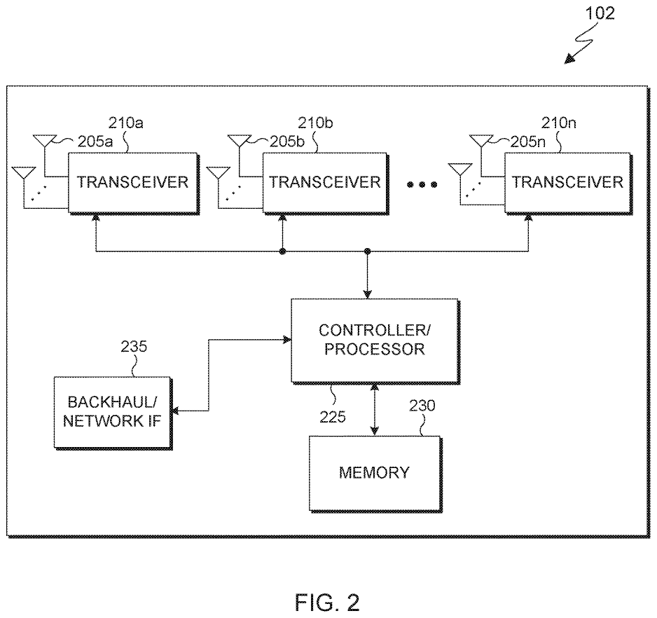

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of the present disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for the processing of CSI for UE-initiated reporting. Any of a wide variety of other functions could be supported in the BS 102 by the controller/processor 225.

The controller/processor 225 is also capable of executing programs and other processes resident in the memory 230, such as processes to support processing of CSI for UE-initiated reporting. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

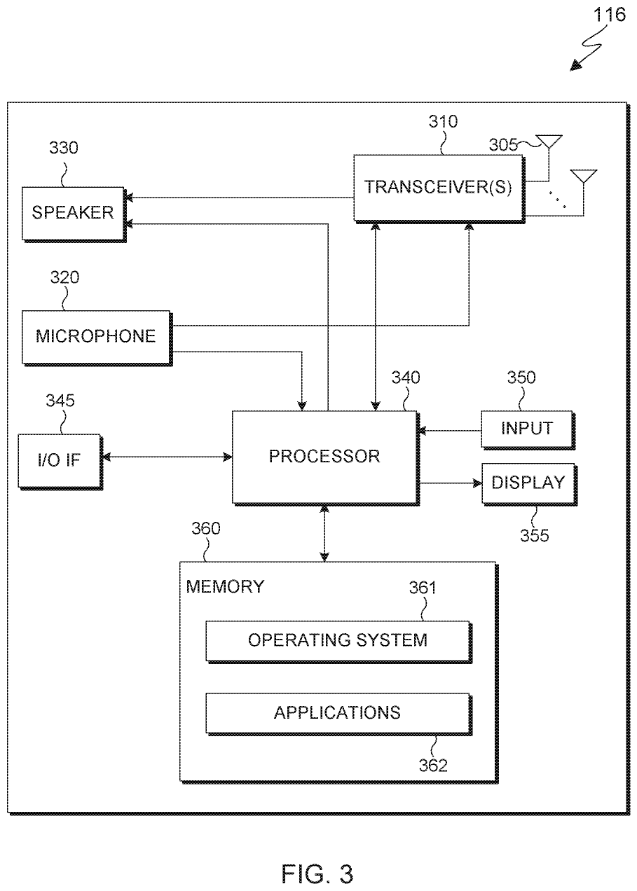

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for supporting UE-initiated reporting of CSI as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

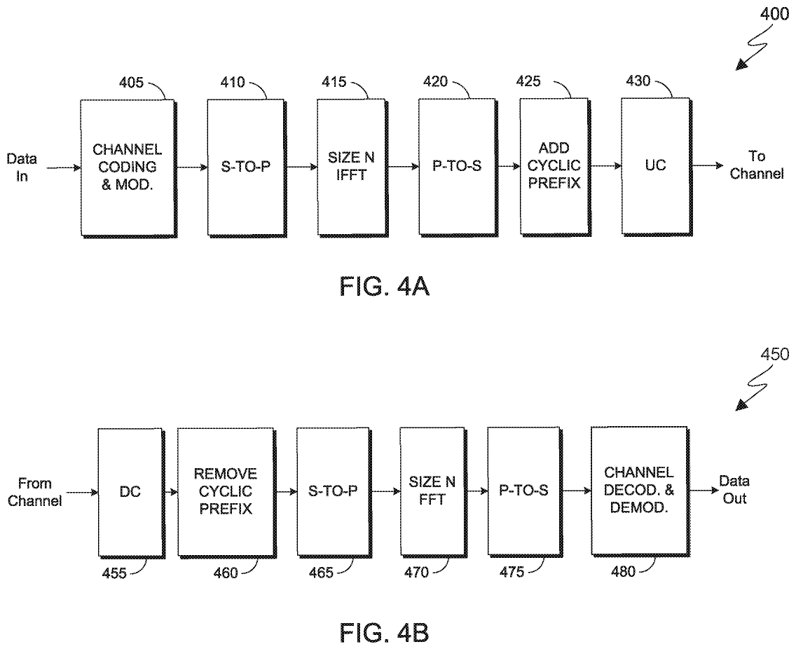

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 and/or the receive path 450 is configured for supporting the processing of CSI for UE-initiated reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 and may implement a receive path 450 for receiving in the downlink from the BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

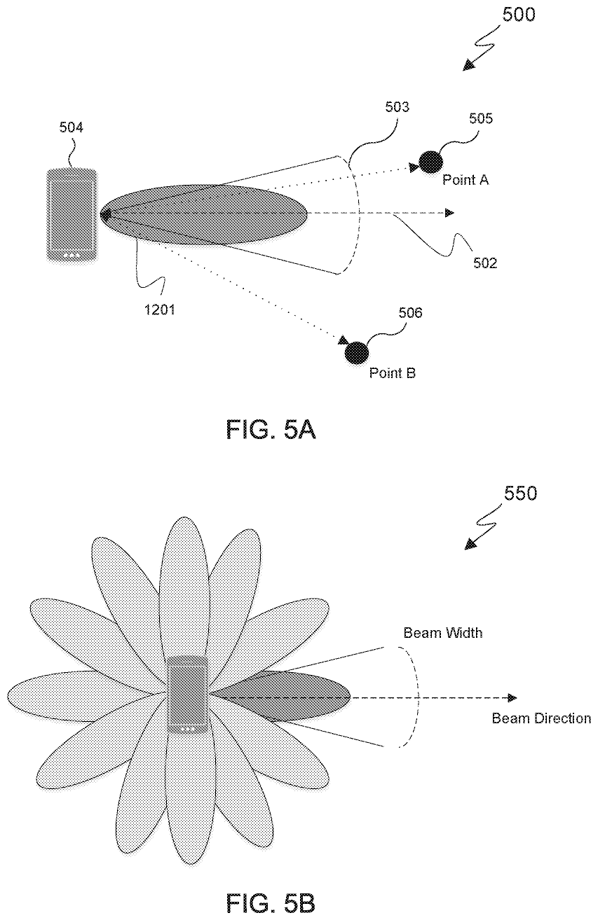

FIG. 5A illustrates an example beam operation 500 in a wireless communication system according to embodiments of the present disclosure. For example, beam operation 500 can be implemented by BS 102 and/or any of the UEs 111-116 of FIG. 1. This example is for illustration only and other embodiments can be used without departing from the scope of the present disclosure.

As illustrated in FIG. 5A, in a wireless system, a beam (501), for a device (504), can be characterized by a beam direction (502) and a beam width (503). For example, a device (504) transmits radio frequency (RF) energy in a beam direction and within a beam width. A device (504) receives RF energy in a beam direction and within a beam width. As illustrated in FIG. 5A, a device at point A (505) can receive from and transmit to device (504) as Point A is within a beam width and direction of a beam from device (504). As illustrated in FIG. 5A, a device at point B (506) cannot receive from and transmit to device (504) as Point B is outside a beam width and direction of a beam from device (504). While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example multi-beam operation 550 in a wireless communication system according to embodiments of the present disclosure. For example, multi-beam operation 550 can be implemented by BS 102 and/or any of the UEs 111-116 of FIG. 1. This example is for illustration only and other embodiments can be used without departing from the scope of the present disclosure.

As illustrated in FIG. 5B, in a wireless system, a device can transmit and/or receive on multiple beams. This is known as “multi-beam operation.” While FIG. 5B, for illustrative purposes, shows beams in 2D, it should be apparent to those skilled in the art that beams can be 3D, where the beams can be transmitted to or received from any direction in space.

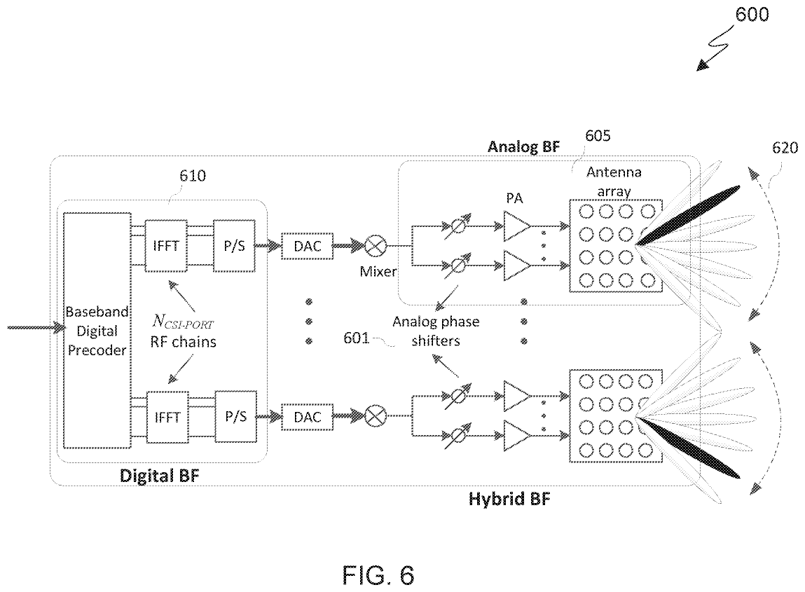

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports NCSI-PORT. A digital beamforming unit 610 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

In new radio (NR) specifications, up to Rel-17, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant implementations the network (NW)/gNB lacks knowledge on the DL channel condition—or, in other words, the UE knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from traditional beam or CSI reports) and application implementations.

Although UE-initiated/event-driven reporting can be beneficial, efficient designs are needed to ensure that the latency is reduced and, at the same time, error events can be minimized. Therefore, there is a need for efficient designs for UE-initiated/event-driven reporting for a content that can offer good trade-off between latency and reliability, in particular, when the UE-initiated/event-driven beam management framework can include multiple report types (or report quantities), or/and multiple event types when a report type can be associated with an event (e.g. for beam report, the event can be beam failure, and for CSI, the event can be user throughput degradation or increasing retransmission rate).

The present disclosure provides various novel and detailed design examples on the UE-initiated/event-driven beam management framework including UE-initiated/event-driven beam reporting. To better support/enable the UE-initiated and the event-based beam operations, this disclosure presents example embodiments on mechanisms and/or procedures of transmitting the UE-initiated report(s) along with its indicator(s) via various uplink channels, and configuring and determining measurement reference signals (RS) resource(s) for the UE-initiated/event-driven beam operations. In addition, the present disclosure provides various report formats customized for the UE-initiated/event-driven beam reporting, and specifies different conditions or settings to apply or use different report formats. Mechanisms of detecting/declaring different events or combinations of different events, and designs of their corresponding configurations and signaling details including channel state information (CSI) processing such as CSI reference resource determination, counting of their unoccupied CSI processing unit (CPU) and active resource(s), and etc. are provided as well.

In the present disclosure, UE-initiated (UEI) reporting is provided.

For a UE configured with a CSI-ReportConfig with eventType-r19 for periodic reference signals with the same periodicity configured by the newBeamResourceSet-r19 and with dl-OrJointTCI-StateList or ul-TCI-StateList, when an event instance is determined,
for a reference signal configured by the newBeamResourceSet-r19, if eventType-r19 is set to ‘event2’ or ‘event7’, or
for the reference signal in the indicated TCI state or the SS/PBCH block which is QCLed with the reference signal in the indicated TCI, if eventType-r19 is set to ‘event1’,
if eventDetectionTimeWindowLength-r19 is provided, the UE starts a time window for such reference signal—e.g., from the first transmission occasion of such reference signal that determines the event instance, wherein the time window does not overlap (e.g., in time or time domain) with other time windows for such reference signal.

When the number of event instances determined for such reference signal within the time window, if eventDetectionTime WindowLength-r19 is provided, is greater than or equal to 1 or to eventlnstanceCount-r19, if provided, which can be referred to as satisfying the corresponding event or event condition(s) wherein the event is provided by eventType-r19, the UE transmits PUCCH format 0 or format 1 in the PUCCH resource configured by PUCCHResource-r19 in the CSI-ReportConfig—herein, the PUCCH/PUCCH resource can be referred to as specific, associated or corresponding to the event evaluation or determination.

The counting of the event instances for such reference signal could be (re-)started if the reference signal in the indicated TCI state or the SS/PBCH block which is QCLed with the reference signal in the indicated TCI state is updated.

In one embodiment, for a UE configured with a CSI-ReportConfig with the higher layer parameter eventType-r19 set to ‘event2’, an event instance is determined for a reference signal configured by the newBeamResourceSet-r19 (in a same CC of CSI-ReportConfig, or in the CC provided by carrier in the CSI-ReportConfig)—denoted by/as a first reference signal—if the L1-RSRP value determined for a transmission occasion of such reference signal (or the first reference signal) is an eventThreshold-r19 greater than the L1-RSRP value determined for a transmission occasion of
the reference signal in the indicated TCI state (applied to the same CC of the reference signal configured by the newBeamResourceSet-r19, or to the CC indicated by CCoflndicatedTCI-r19 in the CSI-ReportConfig)—denoted by/as a second reference signal, if newBeamResourceSet-r19 is a NZP-CSI-RS-ResourceSet configured with repetition, wherein when/if the UE is configured with SSB-MTC-AdditionalPCI, the reference signal in the indicated TCI state could be associated with a PCI (e.g., a/the serving cell PCI or a PCI other than the serving cell PCI) or a PCI index pointing to the PCI from/in a list/set/pool of PCIs higher layer configured or provided to the UE such that the reference signal herein could be associated with a SS/PBCH (SSB)—e.g., the SSB could be QCLed with the reference signal, and the SSB is associated with a/the (same) PCI or PCI index
   in one example, a/the TCI state—e.g., the higher layer parameter TCI-State that configures or provides the TCI state—that has the SSB as a/the (QCL source) reference signal provided or indicated or configured therein and the reference signal in the indicated TCI state as a/the (QCL target) reference signal could include, contain, comprise, provide or configure a/the (same) PCI or PCI index
   in another example, a/the SSB index of or corresponding to the SSB could be in a/the CSI-SSB-ResourceSet that includes one set of SSB indices and one set of PCI indices, where each SSB index is associated with a PCI index; for this example, a/the SSB index of or corresponding to the SSB could be associated with a/the (same) PCI or PCI index,
else,
the SS/PBCH block which is QCLed with the reference signal in the indicated TCI state (applied to the same CC of the reference signal configured by the newBeamResourceSet-r19 or to the CC indicated by CCoflndicatedTCI-r19 in the CSI-ReportConfig)—denoted by/as a second reference signal, if newBeamResourceSet-r19 is a CSI-SSB-ResourceSet, wherein when/if the UE is configured with SSB-MTC-AdditionalPCI, the SS/PBCH block (SSB) herein could be associated with a PCI (e.g., a/the serving cell PCI or a PCI other than the serving cell PCI) or a PCI index pointing to the PCI from/in a list/set/pool of PCIs higher layer configured or provided to the UE
   in one example, a/the TCI state—e.g., the higher layer parameter TCI-State that configures or provides the TCI state—that has the SSB as a/the (QCL source) reference signal provided or indicated or configured therein and the reference signal in the indicated TCI state as a/the (QCL target) reference signal could include, contain, comprise, provide or configure a/the (same) PCI or PCI index
   in another example, a/the SSB index of or corresponding to the SSB could be in a/the CSI-SSB-ResourceSet that includes one set of SSB indices and one set of PCI indices, where each SSB index is associated with a PCI index; for this example, a/the SSB index of or corresponding to the SSB could be associated with a/the (same) PCI or PCI index.

The UE, after transmitting PUCCH format 0 or 1 corresponding to a CSI-ReportConfig with eventType-r19, reports in a single reporting instance (or an UEI (CSI/beam) report) nrofReportedRS-UEIBR-r19 CRIs or SSBRIs—when/if the UE is configured with the higher layer parameter SSB-MTC-AdditionalPCI, the NZP CSI-RS resources or SSB resources corresponding to the reported CRIs or SSBRIs could be associated with PCI indices referring to the PCI of the serving cell and PCI(s) different from the PCI of the serving cell within the set of PCIs configured, their absolute L1-RSRP or differential L1-RSRPs and, when eventConditionMetlndicationlnclusion, eventDetectionTimeWindowLength-r19, and eventlnstanceCount-r19 are configured and nrofReportedRS-UEIBR-r19 is set to a value greater than 1, their indications on whether reference signals indicated by reported CRIs or SSBRIs satisfy the event, corresponding to reference signals provided by the newBeamResourceSet-r19 that comprise at least one reference signal that satisfies the event, and, when enabledCurrentBeamReport-r19 is configured, the differential L1-RSRP corresponding to the reference signal in the indicated TCI state, or to the SS/PBCH block which is QCLed with the reference signal in the indicated TCI state (the above can also be referred to as or denoted by UEI report content(s)):
on a PUSCH indicated by the DCI format 0_1/0_2 in a PDCCH reception after the end of the transmitted PUCCH if reportTransmissionMode-r19 is configured as ‘ModeA’ and the CSI trigger state associated with the CSI-ReportConfig is indicated in the CSI request field in the DCI format 0_1/0_2, or
on a type 1 CG-PUSCH configured by configuredPUSCHResourceOfModeB-r19 in the same CC as the corresponding CSI-ReportConfig on the first available transmission occasion numOfSymbols-ModeB-r19 symbols after the end of the transmitted PUCCH if reportTransmissionMode-r19 is configured as ‘ModeB’, where the periodicity of the PUCCH resource and type 1 CG-PUSCH resource is the same, and the CG-PUSCH does not carry UL-SCH.
   The reference signal in the indicated TCI state is the reference signal w.r.t. QCL-TypeD, if there are two QCL RSs in the indicated TCI state.

In one embodiment, for a UE configured with a CSI-ReportConfig with the higher layer parameter eventType-r19 set to ‘event1’, an event instance is determined if the L1-RSRP value determined for a transmission occasion of
the reference signal in the indicated TCI state (applied to the same CC of the reference signal configured by the newBeamResourceSet-r19, or to the CC indicated by CCoflndicatedTCI-r19 in the CSI-ReportConfig)—denoted by/as a second reference signal, if newBeamResourceSet-r19 is a NZP-CSI-RS-ResourceSet configured with repetition, wherein when/if the UE is configured with SSB-MTC-AdditionalPCI, the reference signal in the indicated TCI state could be associated with a PCI (e.g., a/the serving cell PCI or a PCI other than the serving cell PCI) or a PCI index pointing to the PCI from/in a list/set/pool of PCIs higher layer configured or provided to the UE such that the reference signal herein could be associated with a SS/PBCH (SSB)—e.g., the SSB could be QCLed with the reference signal, and the SSB is associated with a/the (same) PCI or PCI index
   in one example, a/the TCI state—e.g., the higher layer parameter TCI-State that configures or provides the TCI state—that has the SSB as a/the (QCL source) reference signal provided or indicated or configured therein and the reference signal in the indicated TCI state as a/the (QCL target) reference signal could include, contain, comprise, provide or configure a/the (same) PCI or PCI index
   in another example, a/the SSB index of or corresponding to the SSB could be in a/the CSI-SSB-ResourceSet that includes one set of SSB indices and one set of PCI indices, where each SSB index is associated with a PCI index; for this example, a/the SSB index of or corresponding to the SSB could be associated with a/the (same) PCI or PCI index,
else,
the SS/PBCH block which is QCLed with the reference signal in the indicated TCI state (applied to the same CC of the reference signal configured by the newBeamResourceSet-r19, or to the CC indicated by CCoflndicatedTCI-r19 in the CSI-ReportConfig)—denoted by/as a second reference signal, if newBeamResourceSet-r19 is a CSI-SSB-ResourceSet, wherein when/if the UE is configured with SSB-MTC-AdditionalPCI, the SS/PBCH block (SSB) herein could be associated with a PCI (e.g., a/the serving cell PCI or a PCI other than the serving cell PCI) or a PCI index pointing to the PCI from/in a list/set/pool of PCIs higher layer configured or provided to the UE
   in one example, a/the TCI state—e.g., the higher layer parameter TCI-State that configures or provides the TCI state—that has the SSB as a/the (QCL source) reference signal provided or indicated or configured therein and the reference signal in the indicated TCI state as a/the (QCL target) reference signal could include, contain, comprise, provide or configure a/the (same) PCI or PCI index
   in another example, a/the SSB index of or corresponding to the SSB could be in a/the CSI-SSB-ResourceSet that includes one set of SSB indices and one set of PCI indices, where each SSB index is associated with a PCI index; for this example, a/the SSB index of or corresponding to the SSB could be associated with a/the (same) PCI or PCI index
is lower than eventThreshold-Event1-r19, where newBeamResourceSet-r19 is in a same CC of CSI-ReportConfig, or in the CC provided by carrier in the CSI-ReportConfig.

The UE, after transmitting PUCCH format 0 or 1 corresponding to a CSI-ReportConfig with eventType-r19, reports in a single reporting instance (or an UEI (CSI/beam) report) nrofReportedRS-UEIBR-r19 CRIs or SSBRIs—when/if the UE is configured with the higher layer parameter SSB-MTC-AdditionalPCI, the NZP CSI-RS resources or SSB resources corresponding to the reported CRIs or SSBRIs could be associated with PCI indices referring to the PCI of the serving cell and PCI(s) different from the PCI of the serving cell within the set of PCIs configured, and their absolute L1-RSRP or differential L1-RSRPs, corresponding to reference signals provided by the newBeamResourceSet-r19, and, when enabledCurrentBeamReport-r19 is configured, the absolute L1-RSRP corresponding to the reference signal in the indicated TCI state, or to the SSB which is QCLed with the reference signal in the indicated TCI state (the above can also be referred to as or denoted by UEI report content(s)):
on a PUSCH indicated by the DCI format 0_1/0_2 in a PDCCH reception after the end of the transmitted PUCCH if reportTransmissionMode-r19 is configured as ‘ModeA’ and the CSI trigger state associated with the CSI-ReportConfig is indicated in the CSI request field in the DCI format 0_1/0_2, or
   on a type 1 CG-PUSCH configured by configuredPUSCHResourceOfModeB-r19 in the same CC as the corresponding CSI-ReportConfig, on the first available transmission occasion numOfSymbols-ModeB-r19 symbols after the end of the transmitted PUCCH if reportTransmissionMode-r19 is configured as ‘ModeB’, where the periodicity of the PUCCH resource and type 1 CG-PUSCH resource is the same, and the CG-PUSCH does not carry UL-SCH.
      The reference signal in the indicated TCI state is the reference signal w.r.t. QCL-TypeD, if there are two QCL RSs in the indicated TCI state.

In one embodiment, for a UE configured with a CSI-ReportConfig with the higher layer parameter eventType-r19 set to ‘event7’, an event instance is determined for a reference signal configured by the newBeamResourceSet-r19 (in a same CC of CSI-ReportConfig, or in the CC provided by carrier in the CSI-ReportConfig)—denoted by/as a first reference signal—if the L1-RSRP value determined for a transmission occasion of such reference signal (i.e., the first reference signal) is an eventThreshold-r19 greater than the L1-RSRP value determined for a transmission occasion of
the reference signal with the valueOfQ-r19 highest L1-RSRP out of the reference signals among the activated TCI states (applied to the same CC of CSI-ReportConfigCSI-ReportConfig, or to the CC indicated by CCoflndicatedTCI-r19 in the CSI-ReportConfig)—denoted by/as a second reference signal, if newBeamResourceSet-r19 is a NZP-CSI-RS-ResourceSet configured with repetition, wherein when/if the UE is configured with SSB-MTC-AdditionalPCI, the aforementioned reference signal could be associated with a PCI (e.g., a/the serving cell PCI or a PCI other than the serving cell PCI) or a PCI index pointing to the PCI from/in a list/set/pool of PCIs higher layer configured or provided to the UE such that the reference signal herein could be associated with a SS/PBCH (SSB)—e.g., the SSB could be QCLed with the reference signal, and the SSB is associated with a/the (same) PCI or PCI index
   in one example, a/the TCI state—e.g., the higher layer parameter TCI-State that configures or provides the TCI state—that has the SSB as a/the (QCL source) reference signal provided or indicated or configured therein and the aforementioned reference signal as a/the (QCL target) reference signal could include, contain, comprise, provide or configure a/the (same) PCI or PCI index
   in another example, a/the SSB index of or corresponding to the SSB could be in a/the CSI-SSB-ResourceSet that includes one set of SSB indices and one set of PCI indices, where each SSB index is associated with a PCI index; for this example, a/the SSB index of or corresponding to the SSB could be associated with a/the (same) PCI or PCI index,
else,
a SS/PBCH block corresponding to
   setting-I: the SS/PBCH block with the valueOfQ-r19 highest L1-RSRP out of the SS/PBCH blocks QCLed with the reference signals among the activated TCI states (applied to the same CC of CSI-ReportConfigCSI-ReportConfig, or to the CC indicated by CCoflndicatedTCI-r19 in the CSI-ReportConfig)—denoted by/as a second reference signal, if newBeamResourceSet-r19 is a CSI-SSB-ResourceSet.
   setting-II: the SS/PBCH block QCLed with the reference signal with the valueOfQ-r19 highest L1-RSRP out of the reference signals among the activated TCI states (applied to the same CC of CSI-ReportConfigCSI-ReportConfig, or to the CC indicated by CCoflndicatedTCI-r19 in the CSI-ReportConfig)—denoted by/as a second reference signal, if newBeamResourceSet-r19 is a CSI-SSB-ResourceSet.
The UE could follow setting-I and/or setting-II to identify/determine the SS/PBCH block according to or following: (1) fixed rule(s)/value(s) in system specification(s) and/or per RRC (re-)configuration, e.g., following setting-I or setting-II, (2) network's configuration(s)/indication(s) e.g. via/by/in higher layer RRC signaling(s)/parameter(s) and/or MAC CE command(s) and/or dynamic DCI based L1 signaling(s) based on or according to UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc. For instance, depending on or according to or based on a corresponding UE's capability or capability signaling, when/if the UE is configured with a/the CSI-ReportConfig with the higher layer parameter ssbDetermination set to ‘type-I’ or ‘setting-I’, the UE could follow those specified/defined in setting-I to identify/determine the SS/PBCH block; and/or when/if the UE is configured with a/the CSI-ReportConfig with the higher layer parameter ssbDetermination set to ‘type-II’ or ‘setting-II’, the UE could follow those specified/defined in setting-II to identify/determine the SS/PBCH block. When/if the UE is configured with SSB-MTC-AdditionalPCI, the SS/PBCH block (SSB) herein could be associated with a PCI (e.g., a/the serving cell PCI or a PCI other than the serving cell PCI) or a PCI index pointing to the PCI from/in a list/set/pool of PCIs higher layer configured or provided to the UE
   in one example, a/the TCI state—e.g., the higher layer parameter TCI-State that configures or provides the TCI state—that has the SSB as a/the (QCL source) reference signal provided or indicated or configured therein and the aforementioned reference signal as a/the (QCL target) reference signal could include, contain, comprise, provide or configure a/the (same) PCI or PCI index
   in another example, a/the SSB index of or corresponding to the SSB could be in a/the CSI-SSB-ResourceSet that includes one set of SSB indices and one set of PCI indices, where each SSB index is associated with a PCI index; for this example, a/the SSB index of or corresponding to the SSB could be associated with a/the (same) PCI or PCI index.

The UE, after transmitting PUCCH format 0 or 1 corresponding to a CSI-ReportConfig with eventType-r19, reports in a single reporting instance (or an UEI (CSI/beam) report) nrofReportedRS-UEIBR-r19 CRIs or SSBRIs—when/if the UE is configured with the higher layer parameter SSB-MTC-AdditionalPCI, the NZP CSI-RS resources or SSB resources corresponding to the reported CRIs or SSBRIs could be associated with PCI indices referring to the PCI of the serving cell and PCI(s) different from the PCI of the serving cell within the set of PCIs configured, their absolute L1-RSRP or differential L1-RSRPs and, when eventConditionMetlndicatorlnclusion, eventDetectionTimeWindowLength-r19, and eventlnstanceCount-r19 are configured and nrofReportedRS-UEIBR-r19 is set to a value greater than 1, their indications on whether reference signals indicated by reported CRIs or SSBRIs satisfy the event, corresponding to reference signals provided by the newBeamResourceSet-r19 that comprise at least one reference signal that satisfies the event, and, when enabledCurrentBeamReport-r19 is configured, the differential L1-RSRP corresponding to the reference signal with the valueOfQ-r19 highest L1-RSRP out of the activated TCI state reference signals, or to the SSB which is QCLed with the reference signal with the valueOfQ-r19 highest L1-RSRP out of the activated TCI state reference signals (the above can also be referred to as or denoted by UEI report content(s)):
on a PUSCH indicated by the DCI format 0_1/0_2 in a PDCCH reception after the end of the transmitted PUCCH if reportTransmissionMode-r19 is configured as ‘ModeA’ and the CSI trigger state associated with the CSI-ReportConfig is indicated in the CSI request field in the DCI format 0_1/0_2, or
on a type 1 CG-PUSCH configured by configuredPUSCHResourceOjModeB-r19 in the same CC as the corresponding CSI-ReportConfig, which is the first available transmission occasion numOfSymbols-ModeB-r19 symbols after the end of the transmitted PUCCH if reportTransmissionMode-r19 is configured as ‘ModeB’, where the periodicity of the PUCCH resource and type 1 CG-PUSCH resource is the same, and the CG-PUSCH does not carry UL-SCH.
   The reference signal with the valueOfQ-r19 highest L1-RSRP out of the activated TCI state reference signals is the reference signal w.r.t. QCL-TypeD, if there are two QCL RSs in such activated TCI state.

For a UE configured with multiple CSI-ReportConfig in a same CC with same higher layer parameters eventType-r19, firstPUCCHResourceConfig-UEIBR-r19, and reportTransmissionMode-r19, the UE expects
the multiple CSI-ReportConfig to be associated with a same CSI trigger state if reportTransmissionMode-r19 is configured as ‘ModeA’, else
the same configuredPUSCHResourceOfModeB-r19 if reportTransmissionMode-r19 is configured as ‘ModeB’, and
when reporting in a single reporting instance nrofReportedRS-UEIBR-r19 CRIs or SSBRIs corresponding to reference signals provided by the newBeamResourceSet-r19 in a CSI-ReportConfig that satisfies the event, the CSI report contains the corresponding CSI-ReportConfigId and is zero padded to a fixed payload size (when needed), with the fixed payload size given by the maximum payload size among all the multiple CSI-ReportConfig.

In the present disclosure, determination of CSI reference resources is provided.

In one embodiment, for a UE configured with a CSI-ReportConfig with the higher layer parameter eventType-r19 set to ‘event1’, ‘event2’ or ‘event7’, and the higher layer parameter reportTransmissionMode-r19 set to ‘ModeA’, the CSI reference resource for the UEI reporting for a serving cell could be determined or defined as follows:
In the frequency domain, the CSI reference resource is defined by the group of downlink physical resource blocks corresponding to the band to which the derived CSI relates.
In the time domain,
   In one example, the CSI reference resource for an uplink slot n′ is defined by a single downlink slot

$$n - {n}_{CSI \_ ref} - {K}_{offset} \cdot \frac{{2}^{{μ}_{DL}}}{{2}^{{μ}_{{K}_{offset}}}} ,$$

where K_{offset} is a parameter configured by higher layer as specified in clause 4.2 of [6, REF 3], and where μ_{K}_{_{offset}} is the subcarrier spacing configuration for K_{offset} with a value of 0 for frequency range 1 and for FR2-NTN,
   where

$$n = ⌊ {n}^{′} \cdot \frac{{2}^{{μ}_{DL}}}{{2}^{{μ}_{UL}}} ⌋ + ⌊ ( \frac{{N}_{s lot , offset , UL}^{CA}}{{2}^{{μ}_{offset , UL}}} - \frac{{N}_{s lot , offset , D L}^{C A}}{{2}^{{μ}_{offset , DL}}} ) \cdot {2}^{{μ}_{D L}} ⌋$$

an μ_{DL} and μ_{UL} are the subcarrier spacing configurations for DL and UL, respectively, and

$${N}_{slot , offset}^{C A}$$

and μ_{offset} are determined by higher-layer configured ca-SlotOffset for the cells transmitting the uplink and downlink, as defined in clause 4.5 of [4, TS 38.211]
where for the UEI (CSI/beam) reporting, if the UE is indicated by the DCI format 0_1/0_2 in a PDCCH reception after the end of the transmitted PUCCH as specified/described herein in the present disclosure to report the corresponding UEI report content(s) in the same slot as the CSI request, n_{CSI_ref} is such that the reference resource is in the same valid downlink slot as the corresponding CSI request, otherwise n_{CSI_ref} is the smallest value greater than or equal to

$$⌊ {Z}^{′} / {N}_{s y m b}^{slot} ⌋ ,$$

such that slot n−n_{CSI_ref} corresponds to a valid downlink slot, where Z′ corresponds to the delay requirement defined/specified herein in the present disclosure—herein, the CSI reference resource can be considered as specific, associated or corresponding to the transmitted PUCCH and/or the PDCCH reception and/or the PUSCH indicated by the DCI format 0_1/0_2 in the PDCCH reception.
when periodic CSI-RS or SSB is used for event evaluation, channel measurements and etc. according to those specified/defined herein in the present disclosure, the UE is not expected to perform/conduct event evaluation(s), measure channel and etc. on the periodic CSI-RS/SSB whose last OFDM symbol is received up to Z′ symbols before transmission time of the first OFDM symbol of the UEI (CSI/beam) reporting.
In another example, the CSI reference resource for a downlink slot n is defined by a single downlink slot

$$n - {n}_{CSI \_ ref} - {K}_{offset} \cdot \frac{{2}^{{μ}_{DL}}}{{2}^{{μ}_{{K}_{offset}}}} ,$$

where K_{offset} is a parameter configured by higher layer as specified in clause 4.2 of [6, REF 3], and where μ_{K}_{_{offset}} is the subcarrier spacing configuration for K_{offset} with a value of 0 for frequency range 1 and for FR2-NTN,
where for the UEI (CSI/beam) reporting, if the UE is indicated by the DCI format 0_1/0_2 in a PDCCH reception after the end of the transmitted PUCCH as specified/described herein in the present disclosure to report the corresponding UEI report content(s) in the same slot as the CSI request, n_{CSI_ref} is such that the reference resource is in the same valid downlink slot as the corresponding CSI request, otherwise n_{CSI_ref} is the smallest value greater than or equal to

$$⌊ {Z}^{′} / {N}_{s y m b}^{slot} ⌋ ,$$

such that slot n−n_{CSI_ref} corresponds to a valid downlink slot, where Z′ corresponds to the delay requirement defined/specified herein in the present disclosure—herein, the CSI reference resource can be considered as specific, associated or corresponding to the transmitted PUCCH and/or the PDCCH reception and/or the PUSCH indicated by the DCI format 0_1/0_2 in the PDCCH reception.
when periodic CSI-RS or SSB is used for event evaluation, channel measurements and/or etc. according to those specified/defined herein in the present disclosure, the UE is not expected to perform/conduct event evaluation(s), measure channel and/or etc. on the periodic CSI-RS/SSB whose last OFDM symbol is received up to Z′ symbols before transmission time of the first OFDM symbol of the UEI (CSI/beam) reporting.

The UE could determine or identify that the uplink slot n′ as in the one of the examples above could be for or could correspond to one or more of:
(uplink slot-1): UEI (CSI/beam) reporting, or sending or transmitting a UEI (CSI/beam) report as specified/defined herein in the present disclosure via the PUSCH indicated by the DCI format 0_1/0_2 in a PDCCH reception after the end of (or in response to) the (transmitted) PUCCH that carries or conveys the UEIRI
(uplink slot-2): sending or transmitting the PUSCH indicated by the DCI format 0_1/0_2 in a PDCCH reception after the end of (or in response to) the (transmitted) PUCCH that carries or conveys the UEIRI
(uplink slot-3): sending or transmitting a UEI reporting indication/indicator (UEIRI/UEIR-I) via PUCCH format 0 or format 1 in the PUCCH resource configured by PUCCHResource-r19 in the CSI-ReportConfig with eventType-r19
(uplink slot-4): sending or transmitting PUCCH format 0 or format 1 in the PUCCH resource configured by PUCCHResource-r19 in the CSI-ReportConfig with eventType-r19
(uplink slot-5): a/the earliest (or latest) uplink slot that is at least T_proc symbol(s)/slot(s)/etc. before or prior to the start/first/starting (or end/last/ending) symbol/slot/etc. of the (transmitted) PUCCH that carries or conveys the UEIRI
(uplink slot-6): a/the uplink slot that is nearest to the (transmitted) PUCCH that carries or conveys the UEIRI, and is at least T_proc symbol(s)/slot(s)/etc. before or prior to the start/first/starting (or end/last/ending) symbol/slot/etc. of the (transmitted) PUCCH
(uplink slot-7): a/the earliest (or latest) uplink slot that ends (or starts) at least (or no later than) T_proc symbol(s)/slot(s)/etc. before or prior to the start/first/starting (or end/last/ending) symbol/slot/etc. of the (transmitted) PUCCH that carries or conveys the UEIRI
(uplink slot-8): a/the uplink slot that is nearest to the (transmitted) PUCCH that carries or conveys the UEIRI, and ends (or starts) at least (or no later than) T_proc symbol(s)/slot(s)/etc. before or prior to the start/first/starting (or end/last/ending) symbol/slot/etc. of the (transmitted) PUCCH
(uplink slot-9): a/the earliest (or latest) uplink slot that is at least T_proc symbol(s)/slot(s)/etc. after the start/first/starting (or end/last/ending) symbol/slot/etc. of the (transmitted) PUCCH that carries or conveys the UEIRI
(uplink slot-10): a/the uplink slot that is nearest to the (transmitted) PUCCH that carries or conveys the UEIRI, and is at least T_proc symbol(s)/slot(s)/etc. after the start/first/starting (or end/last/ending) symbol/slot/etc. of the (transmitted) PUCCH
(uplink slot-11): a/the earliest (or latest) uplink slot that ends (or starts) at least (or no earlier than) T_proc symbol(s)/slot(s)/etc. after the start/first/starting (or end/last/ending) symbol/slot/etc. of the (transmitted) PUCCH that carries or conveys the UEIRI
(uplink slot-12): a/the uplink slot that is nearest to the (transmitted) PUCCH that carries or conveys the UEIRI, and ends (or starts) at least (or no earlier than) T_proc symbol(s)/slot(s)/etc. after the start/first/starting (or end/last/ending) symbol/slot/etc. of the (transmitted) PUCCH
(uplink slot-13): a/the earliest (or latest) uplink slot that is at least T_proc′ symbol(s)/slot(s)/etc. before or prior to the start/first/starting (or end/last/ending) symbol/slot/etc. of the PUSCH indicated by the DCI format 0_1/0_2 in a PDCCH reception after the end of (or in response to) the (transmitted) PUCCH that carries or conveys the UEIRI
(uplink slot-14): a/the uplink slot that is nearest to the PUSCH indicated by the DCI format 0_1/0_2 in a PDCCH reception after the end of (or in response to) the (transmitted) PUCCH that carries or conveys the UEIRI, and is at least T_proc′ symbol(s)/slot(s)/etc. before or prior to the start/first/starting (or end/last/ending) symbol/slot/etc. of the PUSCH
(uplink slot-15): a/the earliest (or latest) uplink slot that ends (or starts) at least (or no later than) T_proc′ symbol(s)/slot(s)/etc. before or prior to the start/first/starting (or end/last/ending) symbol/slot/etc. of the PUSCH indicated by the DCI format 0_1/0_2 in a PDCCH reception after the end of (or in response to) the (transmitted) PUCCH that carries or conveys the UEIRI
(uplink slot-16): a/the uplink slot that is nearest to the PUSCH indicated by the DCI format 0_1/0_2 in a PDCCH reception after the end of (or in response to) the (transmitted) PUCCH that carries or conveys the UEIRI, and ends (or starts) at least (or no later than) T_proc′ symbol(s)/slot(s)/etc. before or prior to the start/first/starting (or end/last/ending) symbol/slot/etc. of the PUSCH
(uplink slot-17): a/the earliest (or latest) uplink slot that is at least T_gap symbol(s)/slot(s)/etc. before or prior to the start/first/starting (or end/last/ending) symbol/slot/etc. of the PDCCH reception carrying or conveying the DCI format 0_1/0_2 after the end of (or in response to) the (transmitted) PUCCH that carries or conveys the UEIRI
(uplink slot-18): a/the uplink slot that is nearest to the PDCCH reception carrying or conveying the DCI format 0_1/0_2 after the end of (or in response to) the (transmitted) PUCCH that carries or conveys the UEIRI, and is at least T_gap symbol(s)/slot(s)/etc. before or prior to the start/first/starting (or end/last/ending) symbol/slot/etc. of the PDCCH reception
(uplink slot-19): a/the earliest (or latest) uplink slot that ends (or starts) at least (or no later than) T_gap symbol(s)/slot(s)/etc. before or prior to the start/first/starting (or end/last/ending) symbol/slot/etc. of the PDCCH reception carrying or conveying the DCI format 0_1/0_2 after the end of (or in response to) the (transmitted) PUCCH that carries or conveys the UEIRI
(uplink slot-20): a/the uplink slot that is nearest to the PDCCH reception carrying or conveying the DCI format 0_1/0_2 after the end of (or in response to) the (transmitted) PUCCH that carries or conveys the UEIRI, and ends (or starts) at least (or no later than) T_gap symbol(s)/slot(s)/etc. before or prior to the start/first/starting (or end/last/ending) symbol/slot/etc. of the PDCCH reception
(uplink slot-21): a/the earliest (or latest) uplink slot that is at least T_gap symbol(s)/slot(s)/etc. after the start/first/starting (or end/last/ending) symbol/slot/etc. of the PDCCH reception carrying or conveying the DCI format 0_1/0_2 after the end of (or in response to) the (transmitted) PUCCH that carries or conveys the UEIRI
(uplink slot-22): a/the uplink slot that is nearest to the PDCCH reception carrying or conveying the DCI format 0_1/0_2 after the end of (or in response to) the (transmitted) PUCCH that carries or conveys the UEIRI, and is at least T_gap symbol(s)/slot(s)/etc. after the start/first/starting (or end/last/ending) symbol/slot/etc. of the PDCCH reception
(uplink slot-23): a/the earliest (or latest) uplink slot that ends (or starts) at least (or no earlier than) T_gap symbol(s)/slot(s)/etc. after the start/first/starting (or end/last/ending) symbol/slot/etc. of the PDCCH reception carrying or conveying the DCI format 0_1/0_2 after the end of (or in response to) the (transmitted) PUCCH that carries or conveys the UEIRI
(uplink slot-24): a/the uplink slot that is nearest to the PDCCH reception carrying or conveying the DCI format 0_1/0_2 after the end of (or in response to) the (transmitted) PUCCH that carries or conveys the UEIRI, and ends (or starts) at least (or no earlier than) T_gap symbol(s)/slot(s)/etc. after the start/first/starting (or end/last/ending) symbol/slot/etc. of the PDCCH reception
wherein according to or based on or following: (1) fixed rule(s)/value(s) in system specification(s) and/or per RRC (re-)configuration—e.g., the uplink slot n′ as in one of the examples above could be for or could correspond to the uplink slot that starts (or ends) earlier/earliest (or later/latest) in time among the uplink slot-1, uplink slot-2, . . . , uplink slot-24 as specified/defined herein in the present disclosure, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc., and the UE could determine the value(s) of T_proc, T_proc′ and/or T_gap according to or based on: (1) fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc.

The UE could determine or identify that the downlink slot n as in one of the examples above could be for or could correspond to one or more of:
(downlink slot-1): receiving the PDCCH that carries or conveys the DCI format 0_1/0_2 after the end of (or in response to) the (transmitted) PUCCH that carries or conveys the UEIRI
(downlink slot-2): a/the earliest (or latest) downlink slot that is at least T_0 symbol(s)/slot(s)/etc. after the start/first/starting (or end/last/ending) symbol/slot/etc. of the (transmitted) PUCCH that carries or conveys the UEIRI
(downlink slot-3): a/the downlink slot that is nearest to the (transmitted) PUCCH that carries or conveys the UEIRI, and is at least T_0 symbol(s)/slot(s)/etc. after the start/first/starting (or end/last/ending) symbol/slot/etc. of the (transmitted) PUCCH
(downlink slot-4): a/the earliest (or latest) downlink slot that ends (or starts) at least (or no earlier than) T_0 symbol(s)/slot(s)/etc. after the start/first/starting (or end/last/ending) symbol/slot/etc. of the (transmitted) PUCCH that carries or conveys the UEIRI
(downlink slot-5): a/the downlink slot that is nearest to the (transmitted) PUCCH that carries or conveys the UEIRI, and ends (or starts) at least (or no earlier than) T_0 symbol(s)/slot(s)/etc. after the start/first/starting (or end/last/ending) symbol/slot/etc. of the (transmitted) PUCCH
(downlink slot-6): a/the earliest (or latest) downlink slot that is at least T_1 symbol(s)/slot(s)/etc. before or prior to the start/first/starting (or end/last/ending) symbol/slot/etc. of the PUSCH indicated by the DCI format 0_1/0_2 in a PDCCH reception after the end of (or in response to) the (transmitted) PUCCH that carries or conveys the UEIRI
(downlink slot-7): a/the downlink slot that is nearest to the PUSCH indicated by the DCI format 0_1/0_2 in a PDCCH reception after the end of (or in response to) the (transmitted) PUCCH that carries or conveys the UEIRI, and is at least T_1 symbol(s)/slot(s)/etc. before or prior to the start/first/starting (or end/last/ending) symbol/slot/etc. of the PUSCH
(downlink slot-8): a/the earliest (or latest) downlink slot that ends (or starts) at least (or no later than) T_1 symbol(s)/slot(s)/etc. before or prior to the start/first/starting (or end/last/ending) symbol/slot/etc. of the PUSCH indicated by the DCI format 0_1/0_2 in a PDCCH reception after the end of (or in response to) the (transmitted) PUCCH that carries or conveys the UEIRI
(downlink slot-9): a/the downlink slot that is nearest to the PUSCH indicated by the DCI format 0_1/0_2 in a PDCCH reception after the end of (or in response to) the (transmitted) PUCCH that carries or conveys the UEIRI, and ends (or starts) at least (or no later than) T_1 symbol(s)/slot(s)/etc. before or prior to the start/first/starting (or end/last/ending) symbol/slot/etc. of the PUSCH
(downlink slot-10): a/the earliest (or latest) downlink slot that is at least T_2 symbol(s)/slot(s)/etc. before or prior to the start/first/starting (or end/last/ending) symbol/slot/etc. of the PDCCH reception carrying or conveying the DCI format 0_1/0_2 after the end of (or in response to) the (transmitted) PUCCH that carries or conveys the UEIRI
(downlink slot-11): a/the downlink slot that is nearest to the PDCCH reception carrying or conveying the DCI format 0_1/0_2 after the end of (or in response to) the (transmitted) PUCCH that carries or conveys the UEIRI, and is at least T_2 symbol(s)/slot(s)/etc. before or prior to the start/first/starting (or end/last/ending) symbol/slot/etc. of the PDCCH reception
(downlink slot-12): a/the earliest (or latest) downlink slot that ends (or starts) at least (or no later than) T_2 symbol(s)/slot(s)/etc. before or prior to the start/first/starting (or end/last/ending) symbol/slot/etc. of the PDCCH reception carrying or conveying the DCI format 0_1/0_2 after the end of (or in response to) the (transmitted) PUCCH that carries or conveys the UEIRI
(downlink slot-13): a/the downlink slot that is nearest to the PDCCH reception carrying or conveying the DCI format 0_1/0_2 after the end of (or in response to) the (transmitted) PUCCH that carries or conveys the UEIRI, and ends (or starts) at least (or no later than) T_2 symbol(s)/slot(s)/etc. before or prior to the start/first/starting (or end/last/ending) symbol/slot/etc. of the PDCCH reception
(downlink slot-14): a/the earliest (or latest) downlink slot that is at least T_2 symbol(s)/slot(s)/etc. after the start/first/starting (or end/last/ending) symbol/slot/etc. of the PDCCH reception carrying or conveying the DCI format 0_1/0_2 after the end of (or in response to) the (transmitted) PUCCH that carries or conveys the UEIRI
(downlink slot-15): a/the downlink slot that is nearest to the PDCCH reception carrying or conveying the DCI format 0_1/0_2 after the end of (or in response to) the (transmitted) PUCCH that carries or conveys the UEIRI, and is at least T_2 symbol(s)/slot(s)/etc. after the start/first/starting (or end/last/ending) symbol/slot/etc. of the PDCCH reception
(downlink slot-16): a/the earliest (or latest) downlink slot that ends (or starts) at least (or no earlier than) T_2 symbol(s)/slot(s)/etc. after the start/first/starting (or end/last/ending) symbol/slot/etc. of the PDCCH reception carrying or conveying the DCI format 0_1/0_2 after the end of (or in response to) the (transmitted) PUCCH that carries or conveys the UEIRI
(downlink slot-17): a/the downlink slot that is nearest to the PDCCH reception carrying or conveying the DCI format 0_1/0_2 after the end of (or in response to) the (transmitted) PUCCH that carries or conveys the UEIRI, and ends (or starts) at least (or no earlier than) T_2 symbol(s)/slot(s)/etc. after the start/first/starting (or end/last/ending) symbol/slot/etc. of the PDCCH reception
wherein according to or based on or following: (1) fixed rule(s)/value(s) in system specification(s) and/or per RRC (re-)configuration—e.g., the downlink slot n as in one of the examples above could be for or could correspond to the downlink slot that starts (or ends) earlier/earliest (or later/latest) in time among the downlink slot-1, downlink slot-2, . . . , downlink slot-17 as specified/defined herein in the present disclosure, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc., and the UE could determine the value(s) of T_0, T_1 and/or T_2 according to or based on: (1) fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc.

In one embodiment, for a UE configured with a CSI-ReportConfig with the higher layer parameter eventType-r19 set to ‘event1’, ‘event2’ or ‘event7’, and the higher layer parameter reportTransmissionMode-r19 set to ‘ModeB’, the CSI reference resource for the UEI reporting for a serving cell could be determined or defined as follows:
In the frequency domain, the CSI reference resource is defined by the group of downlink physical resource blocks corresponding to the band to which the derived CSI relates.
In the time domain,
   In one example, the CSI reference resource for an uplink slot n′ is defined by a single downlink slot

$$n - {n}_{CSI \_ ref} - {K}_{offset} \cdot \frac{{2}^{{μ}_{DL}}}{{2}^{{μ}_{{K}_{offset}}}} ,$$

where K_{offset} is a parameter configured by higher layer as specified in clause 4.2 of [6, REF 3], and where μ_{K}_{_{offset}} is the subcarrier spacing configuration for K_{offset} with a value of 0 for frequency range 1 and for FR2-NTN,
   where

$$n = ⌊ {n}^{′} \cdot \frac{{2}^{{μ}_{DL}}}{{2}^{{μ}_{UL}}} ⌋ + ⌊ ( \frac{{N}_{s lot , offset , UL}^{CA}}{{2}^{{μ}_{offset , UL}}} - \frac{{N}_{s lot , offset , D L}^{C A}}{{2}^{{μ}_{offset , DL}}} ) \cdot {2}^{{μ}_{D L}} ⌋$$

an μ_{DL} and μ_{UL} are the subcarrier spacing configurations for DL and UL, respectively, and

$${N}_{slot , offset}^{C A}$$

and μ_{offset} are determined by higher-layer configured ca-SlotOffset for the cells transmitting the uplink and downlink, as defined in clause 4.5 of [4, TS 38.211]
where for the UEI (CSI/beam) reporting on the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI
   in one case (case-i), if a single (periodic) CSI-RS/SSB resource is configured for event evaluation(s), channel measurement(s) and/or etc. as specified/defined herein in the present disclosure, n_{CSI_ref} is the smallest value greater than or equal to 4·2^{μ}^{_{DL}}, such that it corresponds to a valid downlink slot, or, if multiple (periodic) CSI-RS/SSB resources are configured for event evaluation(s), channel measurement(s) and/or etc. as specified/defined herein in the present disclosure, n_{CSI_ref} is the smallest value greater than or equal to 5·2^{μ}^{_{DL}}, such that it corresponds to a valid downlink slot
   in another case (case-ii), n_{CSI_ref} is the smallest value greater than or equal to

$$⌊ {Z}^{′} / {N}_{s y m b}^{slot} ⌋ ,$$

such that slot n−n_{CSI_ref} corresponds to a valid downlink slot, where Z′ corresponds to the delay requirement defined/specified herein in the present disclosure
wherein the UE could follow case-i or case-ii to determine n_{CSI_ref} according to or based on: (1) fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc. Herein, the CSI reference resource can be considered as specific, associated or corresponding to the (transmitted) PUCCH and/or the type 1 CG-PUSCH
when periodic CSI-RS or SSB is used for event evaluation, channel measurements and etc. according to those specified/defined herein in the present disclosure, the UE is not expected to perform/conduct event evaluation(s), measure channel and etc. on the periodic CSI-RS/SSB whose last OFDM symbol is received up to Z′ symbols before transmission time of the first OFDM symbol of the UEI (CSI/beam) reporting.
In another example, the CSI reference resource for a downlink slot n is defined by a single downlink slot

$$n - {n}_{CSI \_ ref} - {K}_{offset} \cdot \frac{{2}^{{μ}_{DL}}}{{2}^{{μ}_{{K}_{offset}}}} ,$$

where K_{offset} is a parameter configured by higher layer as specified in clause 4.2 of [6, REF 3], and where μ_{K}_{_{offset}} is the subcarrier spacing configuration for K_{offset} with a value of 0 for frequency range 1 and for FR2-NTN,
   where for the UEI (CSI/beam) reporting on the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI
      in one case (case-i), if a single (periodic) CSI-RS/SSB resource is configured for event evaluation(s), channel measurement(s) and/or etc. as specified/defined herein in the present disclosure, n_{CSI_ref} is the smallest value greater than or equal to 4·2^{μ}^{_{DL}}, such that it corresponds to a valid downlink slot, or, if multiple (periodic) CSI-RS/SSB resources are configured for event evaluation(s), channel measurement(s) and/or etc. as specified/defined herein in the present disclosure, n_{CSI_ref} is the smallest value greater than or equal to 5·2^{μ}^{_{DL}}, such that it corresponds to a valid downlink slot
      in another case (case-ii), n_{CSI_ref} is the smallest value greater than or equal t

$$⌊ {Z}^{′} / {N}_{symb}^{slot} ⌋ ,$$

such that slot n−n_{CSI_ref} corresponds to a valid downlink slot, where Z′ corresponds to the delay requirement defined/specified herein in the present disclosure
wherein the UE could follow case-i or case-ii to determine n_{CSI_ref} according to or based on: (1) fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc. Herein, the CSI reference resource can be considered as specific, associated or corresponding to the (transmitted) PUCCH and/or the type 1 CG-PUSCH
when periodic CSI-RS or SSB is used for event evaluation, channel measurements and/or etc. according to those specified/defined herein in the present disclosure, the UE is not expected to perform/conduct event evaluation(s), measure channel and/or etc. on the periodic CSI-RS/SSB whose last OFDM symbol is received up to Z′ symbols before transmission time of the first OFDM symbol of the UEI (CSI/beam) reporting.

The UE could determine or identify that the uplink slot n′ as in one of the examples above could be for or could correspond to one or more of:
(uplink slot-1): UEI (CSI/beam) reporting, or sending or transmitting a UEI (CSI/beam) report as specified/defined herein in the present disclosure via the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI
(uplink slot-2): sending or transmitting the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI
(uplink slot-3): sending or transmitting a UEI reporting indication/indicator (UEIRI/UEIR-I) via PUCCH format 0 or format 1 in the PUCCH resource configured by PUCCHResource-r19 in the CSI-ReportConfig with eventType-r19
(uplink slot-4): sending or transmitting PUCCH format 0 or format 1 in the PUCCH resource configured by PUCCHResource-r19 in the CSI-ReportConfig with eventType-r19
(uplink slot-5): a/the earliest (or latest) uplink slot that is at least T_proc symbol(s)/slot(s)/etc. before or prior to the start/first/starting (or end/last/ending) symbol/slot/etc. of the (transmitted) PUCCH that carries or conveys the UEIRI
(uplink slot-6): a/the uplink slot that is nearest to the (transmitted) PUCCH that carries or conveys the UEIRI, and is at least T_proc symbol(s)/slot(s)/etc. before or prior to the start/first/starting (or end/last/ending) symbol/slot/etc. of the (transmitted) PUCCH
(uplink slot-7): a/the earliest (or latest) uplink slot that ends (or starts) at least (or no later than) T_proc symbol(s)/slot(s)/etc. before or prior to the start/first/starting (or end/last/ending) symbol/slot/etc. of the (transmitted) PUCCH that carries or conveys the UEIRI
(uplink slot-8): a/the uplink slot that is nearest to the (transmitted) PUCCH that carries or conveys the UEIRI, and ends (or starts) at least (or no later than) T_proc symbol(s)/slot(s)/etc. before or prior to the start/first/starting (or end/last/ending) symbol/slot/etc. of the (transmitted) PUCCH
(uplink slot-9): a/the earliest (or latest) uplink slot that is at least T_proc symbol(s)/slot(s)/etc. after the start/first/starting (or end/last/ending) symbol/slot/etc. of the (transmitted) PUCCH that carries or conveys the UEIRI
(uplink slot-10): a/the uplink slot that is nearest to the (transmitted) PUCCH that carries or conveys the UEIRI, and is at least T_proc symbol(s)/slot(s)/etc. after the start/first/starting (or end/last/ending) symbol/slot/etc. of the (transmitted) PUCCH
(uplink slot-11): a/the earliest (or latest) uplink slot that ends (or starts) at least (or no earlier than) T_proc symbol(s)/slot(s)/etc. after the start/first/starting (or end/last/ending) symbol/slot/etc. of the (transmitted) PUCCH that carries or conveys the UEIRI
(uplink slot-12): a/the uplink slot that is nearest to the (transmitted) PUCCH that carries or conveys the UEIRI, and ends (or starts) at least (or no earlier than) T_proc symbol(s)/slot(s)/etc. after the start/first/starting (or end/last/ending) symbol/slot/etc. of the (transmitted) PUCCH
(uplink slot-13): a/the earliest (or latest) uplink slot that is at least T_proc′ symbol(s)/slot(s)/etc. before or prior to the start/first/starting (or end/last/ending) symbol/slot/etc. of the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI
(uplink slot-14): a/the uplink slot that is nearest to the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, and is at least T_proc′ symbol(s)/slot(s)/etc. before or prior to the start/first/starting (or end/last/ending) symbol/slot/etc. of the PUSCH
(uplink slot-15): a/the earliest (or latest) uplink slot that ends (or starts) at least (or no later than) T_proc′ symbol(s)/slot(s)/etc. before or prior to the start/first/starting (or end/last/ending) symbol/slot/etc. of the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI
(uplink slot-16): a/the uplink slot that is nearest to the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, and ends (or starts) at least (or no later than) T_proc′ symbol(s)/slot(s)/etc. before or prior to the start/first/starting (or end/last/ending) symbol/slot/etc. of the PUSCH
(uplink slot-17): a/the earliest (or latest) uplink slot that is at least numOfSymbols-ModeB-r19 symbols (e.g., one or multiple—e.g., K times—ofnumOfSymbols-ModeB-r19 symbols) before or prior to the start/first/starting (or end/last/ending) symbol/slot/etc. of the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, that could carry or convey a/the UEI (CSI/beam) report(s)
(uplink slot-18): a/the uplink slot that is nearest to the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, and is at least numOfSymbols-ModeB-r19 symbols (e.g., one or multiple—e.g., K times—of numOfSymbols-ModeB-r19 symbols) before or prior to the start/first/starting (or end/last/ending) symbol/slot/etc. of the PUSCH
(uplink slot-19): a/the earliest (or latest) uplink slot that ends (or starts) at least (or no later than) numOfSymbols-ModeB-r19 symbols (e.g., one or multiple—e.g., K times—of numOfSymbols-ModeB-r19 symbols) before or prior to the start/first/starting (or end/last/ending) symbol/slot/etc. of the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, that could carry or convey a/the UEI (CSI/beam) report(s)
(uplink slot-20): a/the uplink slot that is nearest to the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, and ends (or starts) at least (or no later than) numOfSymbols-ModeB-r19 symbols (e.g., one or multiple—e.g., K times—of numOfSymbols-ModeB-r19 symbols) before or prior to the start/first/starting (or end/last/ending) symbol/slot/etc. of the PUSCH
(uplink slot-21): a/the earliest (or latest) uplink slot that is at least T_gap symbols/slots/etc. (e.g., one or multiple—e.g., K′ times—of T_gap symbols/slots/etc.) before or prior to the start/first/starting (or end/last/ending) symbol/slot/etc. of the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, that could carry or convey a/the UEI (CSI/beam) report(s)
(uplink slot-22): a/the uplink slot that is nearest to the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, and is at least T_gap symbols/slots/etc. (e.g., one or multiple—e.g., K′ times—of T_gap symbols/slots/etc.) before or prior to the start/first/starting (or end/last/ending) symbol/slot/etc. of the PUSCH
(uplink slot-23): a/the earliest (or latest) uplink slot that ends (or starts) at least (or no later than) T_gap symbols/slots/etc. (e.g., one or multiple—e.g., K′ times—of T_gap symbols/slots/etc.) before or prior to the start/first/starting (or end/last/ending) symbol/slot/etc. of the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, that could carry or convey a/the UEI (CSI/beam) report(s)
(uplink slot-24): a/the uplink slot that is nearest to the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, and ends (or starts) at least (or no later than) T_gap symbols/slots/etc. (e.g., one or multiple—e.g., K′ times—of T_gap symbols/slots/etc.) before or prior to the start/first/starting (or end/last/ending) symbol/slot/etc. of the PUSCH
wherein according to or based on or following: (1) fixed rule(s)/value(s) in system specification(s) and/or per RRC (re-)configuration—e.g., the uplink slot n′ as in one of the examples above could be for or could correspond to the uplink slot that starts (or ends) earlier/earliest (or later/latest) in time among the uplink slot-1, uplink slot-2, . . . , uplink slot-24 as specified/defined herein in the present disclosure, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc., and the UE could determine the value(s) of K, K′, T_proc and/or T_proc′ according to or based on: (1) fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc. Furthermore, T_gap could correspond to one or more of:
a time offset starting from the end (or start) of a PUCCH of PUCCH format 0 or format 1 in the PUCCH resource configured by PUCCHResource-r19 in the CSI-ReportConfig with eventType-r19 to the start (or end) of a/the nearest (in time) type 1 CG-PUSCH configured by configuredPUSCHResourceOfModeB-r19 in the same CC as the corresponding CSI-ReportConfig that starts (or ends) later in time than the PUCCH
a time offset starting from the end (or start) of a type 1 CG-PUSCH configured by configuredPUSCHResourceOfModeB-r19 in the same CC as the corresponding CSI-ReportConfig to the start (or end) of a/the nearest (in time) PUCCH of PUCCH format 0 or format 1 in the PUCCH resource configured by PUCCHResource-r19 in the CSI-ReportConfig with eventType-r19 that starts (or ends) later in time than the type 1 CG-PUSCH
a (minimum or maximum) time offset between the end (or start) of a PUCCH of PUCCH format 0 or format 1 in the PUCCH resource configured by PUCCHResource-r19 in the CSI-ReportConfig with eventType-r19 and the start (or end) of a type 1 CG-PUSCH configured by configuredPUSCHResourceOfModeB-r19 in the same CC as the corresponding CSI-ReportConfig such that the PUCCH and the type 1 CG-PUSCH are adjacent in time.

The UE could determine or identify that the downlink slot n as in one of the examples above could be for or could correspond to one or more of:
(downlink slot-1): a/the earliest (or latest) downlink slot that is at least T_0 symbol(s)/slot(s)/etc. before or prior to the start/first/starting (or end/last/ending) symbol/slot/etc. of the (transmitted) PUCCH that carries or conveys the UEIRI
(downlink slot-2): a/the downlink slot that is nearest to the (transmitted) PUCCH that carries or conveys the UEIRI, and is at least TO symbol(s)/slot(s)/etc. before or prior to the start/first/starting (or end/last/ending) symbol/slot/etc. of the (transmitted) PUCCH
(downlink slot-3): a/the earliest (or latest) downlink slot that ends (or starts) at least (or no later than) T_0 symbol(s)/slot(s)/etc. before or prior to the start/first/starting (or end/last/ending) symbol/slot/etc. of the (transmitted) PUCCH that carries or conveys the UEIRI
(downlink slot-4): a/the downlink slot that is nearest to the (transmitted) PUCCH that carries or conveys the UEIRI, and ends (or starts) at least (or no later than) T_0 symbol(s)/slot(s)/etc. before or prior to the start/first/starting (or end/last/ending) symbol/slot/etc. of the (transmitted) PUCCH
(downlink slot-5): a/the earliest (or latest) downlink slot that is at least T_0 symbol(s)/slot(s)/etc. after the start/first/starting (or end/last/ending) symbol/slot/etc. of the (transmitted) PUCCH that carries or conveys the UEIRI
(downlink slot-6): a/the downlink slot that is nearest to the (transmitted) PUCCH that carries or conveys the UEIRI, and is at least T_0 symbol(s)/slot(s)/etc. after the start/first/starting (or end/last/ending) symbol/slot/etc. of the (transmitted) PUCCH
(downlink slot-7): a/the earliest (or latest) downlink slot that ends (or starts) at least (or no earlier than) T_0 symbol(s)/slot(s)/etc. after the start/first/starting (or end/last/ending) symbol/slot/etc. of the (transmitted) PUCCH that carries or conveys the UEIRI
(downlink slot-8): a/the downlink slot that is nearest to the (transmitted) PUCCH that carries or conveys the UEIRI, and ends (or starts) at least (or no earlier than) T_0 symbol(s)/slot(s)/etc. after the start/first/starting (or end/last/ending) symbol/slot/etc. of the (transmitted) PUCCH
(downlink slot-9): a/the earliest (or latest) downlink slot that is at least T_1 symbol(s)/slot(s)/etc. before or prior to the start/first/starting (or end/last/ending) symbol/slot/etc. of the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI
(downlink slot-10): a/the downlink slot that is nearest to the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, and is at least T_1 symbol(s)/slot(s)/etc. before or prior to the start/first/starting (or end/last/ending) symbol/slot/etc. of the PUSCH
(downlink slot-11): a/the earliest (or latest) downlink slot that ends (or starts) at least (or no later than) T_1 symbol(s)/slot(s)/etc. before or prior to the start/first/starting (or end/last/ending) symbol/slot/etc. of the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI
(downlink slot-12): a/the downlink slot that is nearest to the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, and ends (or starts) at least (or no later than) T_1 symbol(s)/slot(s)/etc. before or prior to the start/first/starting (or end/last/ending) symbol/slot/etc. of the PUSCH
(downlink slot-13): a/the earliest (or latest) downlink slot that is at least numOfSymbols-ModeB-r19 symbols (e.g., one or multiple—e.g., K times—of numOfSymbols-ModeB-r19 symbols) before or prior to the start/first/starting (or end/last/ending) symbol/slot/etc. of the type 1 CG-PUSCH configured by configuredPUSCHResourceOjModeB-r19 in the same CC as the corresponding CSI-ReportConfig, which is the first available transmission occasion numOfSymbols-ModeB-r19 symbols after the end of the (transmitted) PUCCH that carries or conveys the UEIRI, that could carry or convey a/the UEI (CSI/beam) report(s)
(downlink slot-14): a/the downlink slot that is nearest to the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, and is at least numOfSymbols-ModeB-r19 symbols (e.g., one or multiple—e.g., K times—of numOfSymbols-ModeB-r19 symbols) before or prior to the start/first/starting (or end/last/ending) symbol/slot/etc. of the PUSCH
(downlink slot-15): a/the earliest (or latest) downlnik slot that ends (or starts) at least (or no later than) numOfSymbols-ModeB-r19 symbols (e.g., one or multiple—e.g., K times—of numOfSymbols-ModeB-r19 symbols) before or prior to the start/first/starting (or end/last/ending) symbol/slot/etc. of the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, that could carry or convey a/the UEI (CSI/beam) report(s)
(downlink slot-16): a/the downlink slot that is nearest to the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, and ends (or starts) at least (or no later than) numOfSymbols-ModeB-r19 symbols (e.g., one or multiple—e.g., K times—of numOfSymbols-ModeB-r19 symbols) before or prior to the start/first/starting (or end/last/ending) symbol/slot/etc. of the PUSCH
(downlink slot-17): a/the earliest (or latest) downlink slot that is at least T_gap symbols/slots/etc. (e.g., one or multiple—e.g., K′ times—of T_gap symbols/slots/etc.) before or prior to the start/first/starting (or end/last/ending) symbol/slot/etc. of the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, that could carry or convey a/the UEI (CSI/beam) report(s)
(downlink slot-18): a/the downlink slot that is nearest to the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, and is at least T_gap symbols/slots/etc. (e.g., one or multiple—e.g., K′ times—of T_gap symbols/slots/etc.) before or prior to the start/first/starting (or end/last/ending) symbol/slot/etc. of the PUSCH
(downlink slot-19): a/the earliest (or latest) downlink slot that ends (or starts) at least (or no later than) T_gap symbols/slots/etc. (e.g., one or multiple—e.g., K′ times—of T_gap symbols/slots/etc.) before or prior to the start/first/starting (or end/last/ending) symbol/slot/etc. of the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, that could carry or convey a/the UEI (CSI/beam) report(s)
(downlink slot-20): a/the downlink slot that is nearest to the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI, and ends (or starts) at least (or no later than) T_gap symbols/slots/etc. (e.g., one or multiple—e.g., K′ times—of T_gap symbols/slots/etc.) before or prior to the start/first/starting (or end/last/ending) symbol/slot/etc. of the PUSCH
wherein according to or based on or following: (1) fixed rule(s)/value(s) in system specification(s) and/or per RRC (re-)configuration—e.g., the downlink slot n as in one of the examples above could be for or could correspond to the downlink slot that starts (or ends) earlier/earliest (or later/latest) in time among the downlink slot-1, downlink slot-2, . . . , downlink slot-20 as specified/defined herein in the present disclosure, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc., and the UE could determine the value(s) of K, K′, T_0 and/or T_1 according to or based on: (1) fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc. Furthermore, T_gap could correspond to one or more of:
a time offset starting from the end (or start) of a PUCCH of PUCCH format 0 or format 1 in the PUCCH resource configured by PUCCHResource-r19 in the CSI-ReportConfig with eventType-r19 to the start (or end) of a/the nearest (in time) type 1 CG-PUSCH configured by configuredPUSCHResourceOfModeB-r19 in the same CC as the corresponding CSI-ReportConfig that starts (or ends) later in time than the PUCCH
a time offset starting from the end (or start) of a type 1 CG-PUSCH configured by configuredPUSCHResourceOfModeB-r19 in the same CC as the corresponding CSI-ReportConfig to the start (or end) of a/the nearest (in time) PUCCH of PUCCH format 0 or format 1 in the PUCCH resource configured by PUCCHResource-r19 in the CSI-ReportConfig with eventType-r19 that starts (or ends) later in time than the type 1 CG-PUSCH
a (minimum or maximum) time offset between the end (or start) of a PUCCH of PUCCH format 0 or format 1 in the PUCCH resource configured by PUCCHResource-r19 in the CSI-ReportConfig with eventType-r19 and the start (or end) of a type 1 CG-PUSCH configured by configuredPUSCHResourceOfModeB-r19 in the same CC as the corresponding CSI-ReportConfig such that the PUCCH and the type 1 CG-PUSCH are adjacent in time.

Throughout the present disclosure, a slot in a serving cell could be considered to be a valid downlink slot if:
it comprises at least one higher layer configured downlink or flexible symbol, and
it does not fall within a configured measurement gap for that UE
   If there is no valid downlink slot for the CSI reference resource corresponding to a CSI Report Setting (e.g., a CSI-ReportConfig with the higher layer parameter eventType-r19 set to ‘event1’, ‘event2’ or ‘event7’, and/or the higher layer parameter reportTransmissionMode-r19 set to ‘ModeA’ or ‘ModeB’) with in a serving cell, the UEI (CSI/beam) reporting is omitted for the serving cell in uplink slot n′ according to or following those specified/defined herein in the present disclosure.

According to or following those specified/defined herein in the present disclosure, for a CSI reference resource specific or associated or corresponding to a PUCCH of PUCCH format 0 or format 1 in a PUCCH resource configured by PUCCHResource-r19 in the CSI-ReportConfig that could carry or convey an UEIRI or UEIR-I according to or following those specified/defined herein in the present disclosure, wherein the start (e.g., the first symbol/slot/etc.) or end (e.g., the last symbol/slot/etc.) of the PUCCH/PUCCH resource is at t, the UE could expect that the slot in which the CSI reference resource is would start or end after t—UEIRI_{PERIODICITY} or t−UEIRI_{PERIODICITY}—T_proc, or the UE may not expect that the slot in which the CSI reference resource is would start or end before or prior to t—UEIRI_{PERIODICITY} or t—UEIRI_{PERIODICITY}-T_proc, wherein
UEIRI_{PERIODICITY} in symbols or slots and an offset UEIRI^{OFFSET} in slots could be provided by periodicityAndOffset for a PUCCH transmission of PUCCH format 0 or format 1 in a PUCCH resource configured by PUCCHResource-r19 in the CSI-ReportConfig with UEIRI or UEIR-I. If UEIRI_{PERIODICITY} is larger than one slot, the UE determines a transmission occasion of a PUCCH with UEIRI or UEIR-I to be in a slot with number

$${n}_{s , f}^{μ}$$

[4, REF 1] in a frame with number n_{f} if

$$( {n}_{f} \cdot {N}_{slot}^{frame , μ} + {n}_{s , f}^{μ} - {UEIRI}_{OFFSET} ) mod {UEIRI}_{PERIODICITY} = 0.$$

$$If {UEIRI}_{PERIODICITY}$$

is one slot, the UE expects that UEIRI_{OFFSET}=0 and every slot is a transmission occasion of a PUCCH with UEIRI or UEIR-I. If UEIRI_{PERIODICITY} is smaller than one slot, the UE determines a transmission occasion of a PUCCH with UEIRI/UEIR-I to start in a symbol with index 1 [4, REF 1] if (l−l₀ modUEIRI_{PERIODICITY})modUEIRI_{PERIODICITY}=0 where l₀ is the value of startingSymbolIndex.
The UE could determine the value(s) of T_proc (the time span/gap/period/offset that the UE requires to prepare the PUCCH) according to or based on or following: (1) fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s)—e.g., T_proc could be provided in the CSI-ReportConfig specific to PUCCH resource(s) configured by PUCCHResource-r19 in the CSI-ReportConfig, and/or (3) UE's autonomous determination/selection, which could be further sent or transmitted or indicated to the network via/by/in various UL channels/signals including CSI/beam report(s), UE's capability signaling(s) and/or etc.

In the present disclosure, UEI (CSI/beam) report computation time is provided.

If the higher layer parameter timeRestrictionForChannelMeasurements in provided in a CSI-ReportConfig with the higher layer parameter eventType-r19 set to ‘event1’, ‘event2’ or ‘event7’ and/or the higher layer parameter reportTransmissionMode-r19 set to ‘ModeA’ or ‘ModeB’, and is set to “notConfigured”, the UE could perform event evaluation(s) for determining the event(s) and/or transmitting/sending a UEIRI (e.g. via PUCCH format 0 or format 1 in the PUCCH resource configured by PUCCHResource-r19 in the CSI-ReportConfig with eventType-r19) in uplink slot n, and/or derive the channel measurements for computing L1-RSRP value(s) for the UEI (CSI/beam) report(s) as specified/defined herein in the present disclosure reported in uplink slot n
on/of a PUSCH indicated by the DCI format 0_1/0_2 in a PDCCH reception after the end of the transmitted PUCCH if reportTransmissionMode-r19 is configured as ‘ModeA’ and the CSI trigger state associated with the CSI-ReportConfig is indicated in the CSI request field in the DCI format 0_1/0_2, or
on/of a type 1 CG-PUSCH configured by configuredPUSCHResourceOjModeB-r19 in the same CC as the corresponding CSI-ReportConfig, which is the first available transmission occasion numOfSymbols-ModeB-r19 symbols after the end of the transmitted PUCCH if reportTransmissionMode-r19 is configured as ‘ModeB’, where the periodicity of the PUCCH resource and type 1 CG-PUSCH resource is the same, and the CG-PUSCH does not carry UL-SCH.
based on only the SS/PBCH block (SSB) or NZP CSI-RS—denoted by/as the reference SSB/NZP CSI-RS for event evaluation(s) and/or channel measurement(s) in the present disclosure, no later than the CSI reference resource (as specified/defined herein in the present disclosure), associated with the corresponding CSI resource setting.

If the higher layer parameter timeRestrictionForChannelMeasurements in provided in a CSI-ReportConfig with the higher layer parameter eventType-r19 set to ‘event1’, ‘event2’ or ‘event7’ and/or the higher layer parameter reportTransmissionMode-r19 set to ‘ModeA’ or ‘ModeB’, and is set to “Configured”, the UE could perform event evaluation(s) for determining the event(s) and/or transmitting/sending a UEIRI (e.g. via PUCCH format 0 or format 1 in the PUCCH resource configured by PUCCHResource-r19 in the CSI-ReportConfig with eventType-r19) in uplink slot n, and/or derive the channel measurements for computing L1-RSRP value(s) for the UEI (CSI/beam) report(s) as specified/defined herein in the present disclosure reported in uplink slot n
on/of a PUSCH indicated by the DCI format 0_1/0_2 in a PDCCH reception after the end of the transmitted PUCCH if reportTransmissionMode-r19 is configured as ‘ModeA’ and the CSI trigger state associated with the CSI-ReportConfig is indicated in the CSI request field in the DCI format 0_1/0_2, or
on/of a type 1 CG-PUSCH configured by configuredPUSCHResourceOjModeB-r19 in the same CC as the corresponding CSI-ReportConfig, which is the first available transmission occasion numOfSymbols-ModeB-r19 symbols after the end of the transmitted PUCCH if reportTransmissionMode-r19 is configured as ‘ModeB’, where the periodicity of the PUCCH resource and type 1 CG-PUSCH resource is the same, and the CG-PUSCH does not carry UL-SCH
based on only the most recent, no later than the CSI reference resource (as specified/defined herein in the present disclosure), occasion of SS/PBCH block (SSB) or NZP CSI-RS—denoted by/as the reference SSB/NZP CSI-RS for event evaluation(s) and/or channel measurement(s) in the present disclosure—associated with the corresponding CSI resource setting.

Furthermore, for a UE configured with a CSI-ReportConfig with the higher layer parameter eventType-r19 set to ‘event1’, ‘event2’ or ‘event7’ and/or the higher layer parameter reportTransmissionMode-r19 set to ‘ModeA’ or ‘ModeB’, when the UE is configured with SSB-MTC-AdditionalPCI, and
if newBeamResourceSet-r19 is a NZP-CSI-RS-ResourceSet configured with repetition, a reference signal configured by the NZP-CSI-RS-ResourceSet (or equivalently the newBeamResourceSet-r19) is associated with a PCI or PCI index when/if a SS/PBCH (SSB) associated with such reference signal—e.g., the SSB could be QCLed with such reference signal—is associated with a/the (same) PCI or PCI index
   in one example, a/the TCI state—e.g., the higher layer parameter TCI-State that configures or provides the TCI state—that has the SSB as a/the (QCL source) reference signal provided or indicated or configured therein and such reference signal as a/the (QCL target) reference signal could include, contain, comprise, provide or configure a/the (same) PCI or PCI index
   in another example, a/the SSB index of or corresponding to the SSB could be in a/the CSI-SSB-ResourceSet that includes one set of SSB indices and one set of PCI indices, where each SSB index is associated with a PCI index; for this example, a/the SSB index of or corresponding to the SSB could be associated with a/the (same) PCI or PCI index
if newBeamResourceSet-r19 is a CSI-SSB-ResourceSet, the CSI-SSB-ResourceSet (or equivalently the newBeamResourceSet-r19) configured for event evaluation(s)—and therefore for determining event instance(s)/event(s) according to or following those specified/defined herein in the present disclosure—and/or L1-RSRP based UEI (CSI/beam) reporting according to or following those specified/defined herein in the present disclosure includes one set of SSB indices and one set of PCI indices, where each SSB index is associated with a PCI index.

For a UE configured with a CSI-ReportConfig with the higher layer parameter eventType-r19 set to ‘event1’, ‘event2’ or ‘event7’ and/or the higher layer parameter reportTransmissionMode-r19 set to ‘ModeA’, when the CSI request field on the DCI format 0_1/0_2 in a PDCCH reception after the end of (or in response to) the (transmitted) PUCCH that carries or conveys a UEIRI indicates a PUSCH for transmitting or sending a UEI (beam/CSI) report as specified/defined herein in the present disclosure, the UE could provide a valid UEI (CSI/beam) report for the n-th (triggered/initiated) report—herein, n 1, . . . , N or n∈{1, . . . , N} with N≥1 representing a/the number of CSI-ReportConfig's in a same CC with same higher layer parameter(s) eventType-r19 and reportTransmissionMode-r19 (e.g., set to ‘ModeA’), and/or e.g. for n∈{1, . . . , N} and/or N>1 the UE could determine or select the value of n for a (same) single reporting instance or UEI (beam/CSI) report as specified/defined herein in the present disclosure; the N CSI-ReportConfig's could be associated with (1) a same CSI trigger state indicated by the CSI request field on the DCI format 0_1/0_2 in a PDCCH reception after the end of (or in response to) the (transmitted) PUCCH that carries or conveys a UEIRI indicates a PUSCH for transmitting or sending a UEI (beam/CSI) report as specified/defined herein in the present disclosure e.g. when/if the NCSI-ReportConfig's are associated with the (transmitted) PUCCH, and/or (2) a same PUCCH resource with PUCCH format 0 or 1 configured by PUCCHResource-r19 that could be used/transmitted to carry or convey a/the UEIRI or UEIR-I—according to or based on one or more of,
in one example, if the first uplink symbol to carry the corresponding UEI (CSI/beam) report(s) including the effect of the timing advance, starts no earlier than at symbol Z_{ref},
in another example, if the first uplink symbol to carry the n-th UEI (CSI/beam) report including the effect of the timing advance, starts no earlier than at symbol Z′_{ref}(n);
in another example, if the first uplink symbol to carry the corresponding UEI (CSI/beam) report(s) including the effect of the timing advance, starts no earlier than at symbol Z_{ref}, and if the first uplink symbol to carry the n-th UEI (CSI/beam) report including the effect of the timing advance, starts no earlier than at symbol Z′_{ref}(n);
in another example, if the first uplink symbol to carry the corresponding UEI (CSI/beam) report(s) and/or the n-th UEI (CSI/beam) report including the effect of the timing advance, starts no earlier than at symbol Z′_{ref}(n) or Z_{ref} that starts (or ends) earlier in time;
in another example, if the first uplink symbol to carry the corresponding UEI (CSI/beam) report(s) and/or the n-th UEI (CSI/beam) report including the effect of the timing advance, starts no earlier than at symbol Z′_{ref}(n) or Z_{ref} that starts (or ends) later in time,
where Z_{ref} is defined as the next uplink symbol with its CP starting T_{proc,CSI}=(Z)(2048+144)·κ2^{-μ}T_{C}+T_{switch} after the end of the last symbol of the PDCCH indicating the PUSCH that carries or conveys the UEI (CSI/beam) report(s), and where Z′_{ref}(n), is defined as the next uplink symbol with its CP starting T′_{proc,CSI}=(Z′)(2048+144)·κ2^{-μ}T_{C} after the end of the last symbol in time of the reference SSB/NZP CSI-RS as specified/defined herein in the present disclosure, when the reference SSB/NZP CSI-RS is used for event evaluation(s) and/or channel measurement(s) for the n-th (triggered) UEI (CSI/beam) report, and where T_{switch} is defined in clause 6.4 of REF 4 and is applied only if Z₁ is applied.

If the PUSCH indicated by the DCI format 0_1/0_2 in a PDCCH reception after the end of (or in response to) the (transmitted) PUCCH that carries or conveys a/the UEIRI or UEIR-I is overlapping with another PUCCH or PUSCH, then the UEI (beam/CSI) report(s) are multiplexed following the procedure in clause 9.2.5 of [6, REF 3] and clause 5.2.5 of REF 4 when applicable, otherwise the UEI (beam/CSI) report(s) as specified/defined herein in the present disclosure are transmitted on the PUSCH indicated by the DCI.

When the CSI request field on the DCI format 0_1/0_2 in a PDCCH reception after the end of (or in response to) the (transmitted) PUCCH that carries or conveys a UEIRI indicates a PUSCH for transmitting or sending a UEI (beam/CSI) report as specified/defined herein in the present disclosure, if the first uplink symbol to carry the corresponding UEI (beam/CSI) report(s) including the effect of the timing advance, starts earlier than at symbol Z_{ref},
the UE may ignore the above scheduling DCI format 0_1/0_2 if no HARQ-ACK or transport block is multiplexed on the PUSCH.

When the CSI request field on the DCI format 0_1/0_2 in a PDCCH reception after the end of (or in response to) the (transmitted) PUCCH that carries or conveys a UEIRI indicates a PUSCH for transmitting or sending a UEI (beam/CSI) report as specified/defined herein in the present disclosure, if the first uplink symbol to carry the n-th UEI (beam/CSI) report including the effect of the timing advance, starts earlier than at symbol Z′_{ref}(n),
the UE may ignore the above scheduling DCI 0_1/0_2 if the number of (triggered/initiated) reports is one and no HARQ-ACK or transport block is multiplexed on the PUSCH
Otherwise, the UE is not required to update the CSI for the n-th (triggered) UEI (CSI/beam) report.

When the above PDCCH reception includes two PDCCH candidates from two respective search space sets, as described in clause 10.1 of [6, REF 3], for the purpose of determining the last symbol of the aforementioned PDCCH reception, the PDCCH candidate that ends later in time is used.

For a UE configured with a CSI-ReportConfig with the higher layer parameter eventType-r19 set to ‘event1’, ‘event2’ or ‘event7’ and/or the higher layer parameter reportTransmissionMode-r19 set to ‘ModeB’, the UE could provide a valid UEI (CSI/beam) report for the n-th (initiated) report—herein, n=1, . . . , N or n∈{1, . . . , N} with N≥1 representing a/the number of CSI-ReportConfig's in a same CC with same higher layer parameter(s) eventType-r19 and reportTransmissionMode-r19 (e.g., set to ‘ModeB’), and/or e.g. for n∈{1, . . . , N} and/or N>1 the UE could determine or select the value of n for a (same) single reporting instance or UEI (beam/CSI) report as specified/defined herein in the present disclosure; the NCSI-ReportConfig's could be associated with a same PUCCH resource with PUCCH format 0 or 1 configured by PUCCHResource-r19 that could be used/transmitted to carry or convey a/the UEIRI or UEIR-I,
if the first uplink symbol to carry the n-th UEI (CSI/beam) report including the effect of the timing advance, starts no earlier than at symbol Z′_{ref}(n),
where Z′ref(n), is defined as the next uplink symbol with its CP starting T′_{proc,CSI}=(Z′)(2048+144)·κ2^{-μ}T_{C} after the end of the last symbol in time of the reference SSB/NZP CSI-RS as specified/defined herein in the present disclosure, when the reference SSB/NZP CSI-RS is used for event evaluation(s) and/or channel measurement(s) for the n-th (initiated) UEI (CSI/beam) report, and where T_{switch} is defined in clause 6.4 of REF 4 and is applied only if Z_{I} is applied.

If the type 1 CG-PUSCH configured by configuredPUSCHResourceOjModeB-r19 in the same CC as the corresponding CSI-ReportConfig, which is the first available transmission occasion numOfSymbols-ModeB-r19 symbols after the end of the (transmitted) PUCCH that carries or conveys a/the UEIRI or UEIR-I, is overlapping with another PUCCH or PUSCH, then the UEI (beam/CSI) report(s) are multiplexed and/or dropped following the procedure in/of [6, REF 3] and in/of REF 4 when applicable, otherwise the UEI (beam/CSI) report(s) as specified/defined herein in the present disclosure are transmitted on the type 1 CG-PUSCH. If the first uplink symbol to carry the n-th UEI (beam/CSI) report including the effect of the timing advance, starts earlier than at symbol Z′_{ref}(n), the UE is not required to update the CSI for the n-th (initiated) UEI (CSI/beam) report. And, Z, Z′ and μ are defined according to those specified in REF 4.

In the present disclosure, priority rules for UEI CSI/beam report(s) are provided.

For two overlapping PUSCHs, the priority rules as specified/defined herein in the present disclosure are applied for physical channels with same priority index according to clause 9 in [6, REF 3] if a UE is not configured with sTx-2Panel or a UE is configured by higher layer parameter PDCCH-Config that contains two different values of coresetPoolIndex in different ControlResourceSet in the active DL BWP and the UE is configured with sTx-2Panel and the two overlapping PUSCHs are associated with same value of coresetPoolIndex.

CSI reports are associated with a priority value Pri_{iCSI} (y, k, c, s)=2·N_{cells}·Mₛ·y+N_{cells}·Mₛ·k+Mₛ·c+s where
y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH;
y=0 for UEI (CSI/beam) reports as specified/defined herein in the present disclosure to be carried on
   PUSCH indicated by the DCI format 0_1/0_2 in a PDCCH reception after the end of (or in response to) the (transmitted) PUCCH that carries or conveys a/the UEIRI or UEIR-I if reportTransmissionMode-r19 is configured as ‘ModeA’; and/or
   type 1 CG-PUSCH configured by configuredPUSCHResourceOjModeB-r19 in the same CC as the corresponding CSI-ReportConfig, which is the first available transmission occasion numOfSymbols-ModeB-r19 symbols after the end of the (transmitted) PUCCH that carries or conveys a/the UEIRI or UEIR-I if reportTransmissionMode-r19 is configured as ‘ModeB’; and/or
y=1 for UEI (CSI/beam) reports as specified/defined herein in the present disclosure to be carried on type 1 CG-PUSCH configured by configuredPUSCHResourceOjModeB-r19 in the same CC as the corresponding CSI-ReportConfig, which is the first available transmission occasion numOfSymbols-ModeB-r19 symbols after the end of the (transmitted) PUCCH that carries or conveys a/the UEIRI or UEIR-I if reportTransmissionMode-r19 is configured as ‘ModeB’;
k=0 for CSI reports carrying L1-RSRP or L1-SINR and k=1 for CSI reports not carrying L1-RSRP or L1-SINR;
c is the serving cell index and N_{cells} is the value of the higher layer parameter maxNrofServingCells;
   for a CSI report configured with LTM-CSI-ReportConfig, c is the serving cell index value where the report configuration is configured.
s is the reportConfigID and Mₛ is the value of the higher layer parameter maxNrofCSI-ReportConfigurations.
   for a CSI report configured with LTM-CSI-ReportConfig, s is the LTM-CSI-ReportConfigID and Ms is the value of the higher layer parameter maxNrofLTM-CSI-ReportConfigurations
      A first CSI report is said to have priority over second CSI report if the associated Pri_{iCSI} (y, k, c, s) value is lower for the first report than for the second report.

Two CSI reports are said to collide if the time occupancy of the physical channels scheduled to carry the CSI reports overlap in at least one OFDM symbol and are transmitted on the same carrier. When a UE is configured to transmit two colliding CSI reports,
if y values are different between the two CSI reports, the following rules apply except for the case when one of the y value is 2 and the other y value is 3 (for CSI reports transmitted on PUSCH, as described in Clause 5.2.3; for CSI reports transmitted on PUCCH, as described in Clause 5.2.4):
   The CSI report with higher Pri_{iCSI} (y, k, c, s) value shall not be sent by the UE.
otherwise, the two CSI reports are multiplexed or either is dropped based on the priority values, as described in Clause 9.2.5.2 in [6, REF 3].

In one example, e.g., for a same Pri_{iCSI} (y, k, c, s) value and/or y value, the UEI (CSI/beam) reports carried on PUSCH indicated by the DCI format 0_1/0_2 in a PDCCH reception after the end of (or in response to) the (transmitted) PUCCH that carries or conveys a/the UEIRI or UEIR-I if reportTransmissionMode-r19 is configured as ‘ModeA’ could have a higher priority (or a lower Pri_{iCSI} (y, k, c, s) value, if applicable) than
the UEI (CSI/beam) reports carried on type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys a/the UEIRI or UEIR-I if reportTransmissionMode-r19 is configured as ‘ModeB’, and/or
aperiodic CSI reports to be carried on PUSCH e.g. with y=0, and/or semi-persistent CSI reports to be carried on PUSCH e.g. with y=1, and/or semi-persistent CSI reports to be carried on PUCCH e.g. with y=2, and/or periodic CSI reports to be carried on PUCCH e.g. with y=3.

In one example, e.g., for a same Pri_{iCSI} (y, k, c, s) value and/or y value, the UEI (CSI/beam) reports carried on type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys a/the UEIRI or UEIR-I if reportTransmissionMode-r19 is configured as ‘ModeB’ could have a higher priority (or a lower Pri_{iCSI} (y, k, c, s) value, if applicable) than
the UEI (CSI/beam) reports carried on PUSCH indicated by the DCI format 0_1/0_2 in a PDCCH reception after the end of (or in response to) the (transmitted) PUCCH that carries or conveys a/the UEIRI or UEIR-I if reportTransmissionMode-r19 is configured as ‘ModeA’, and/or
aperiodic CSI reports to be carried on PUSCH e.g. with y=0, and/or semi-persistent CSI reports to be carried on PUSCH e.g. with y=1, and/or semi-persistent CSI reports to be carried on PUCCH e.g. with y=2, and/or periodic CSI reports to be carried on PUCCH e.g. with y=3.

In one example, e.g., for a same Pri_{iCSI} (y, k, c, s) value and/or y value, aperiodic CSI reports to be carried on PUSCH e.g. withy=0, and/or semi-persistent CSI reports to be carried on PUSCH e.g. with y=1 could have a higher priority (or a lower Pri_{iCSI} (y, k, c, s) value, if applicable) than
the UEI (CSI/beam) reports carried on PUSCH indicated by the DCI format 0_1/0_2 in a PDCCH reception after the end of (or in response to) the (transmitted) PUCCH that carries or conveys a/the UEIRI or UEIR-I if reportTransmissionMode-r19 is configured as ‘ModeA’, and/or
the UEI (CSI/beam) reports carried on type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys a/the UEIRI or UEIR-I if reportTransmissionMode-r19 is configured as ‘ModeB’.

If a UEI (CSI/beam) report as specified/defined herein in the present disclosure to be carried on a type 1 CG-PUSCH configured by configuredPUSCHResourceOjModeB-r19 in the same CC as the corresponding CSI-ReportConfig, which is the first available transmission occasion numOfSymbols-ModeB-r19 symbols after the end of the (transmitted) PUCCH that carries or conveys a/the UEIRI or UEIR-I if reportTransmissionMode-r19 is configured as ‘ModeB’ overlaps in time with PUSCH data transmission in one or more symbols on the same carrier, and if the earliest symbol of these PUSCH channels starts no earlier than N₂+d_{2,1} symbols after the last symbol of the DCI scheduling the PUSCH where d_{2,1} is the maximum of the d_{2,1} associated with the type 1 CG-PUSCH carrying or conveying the UEI (CSI/beam) report and the PUSCH with data transmission, the UEI (CSI/beam) report shall not be transmitted by the UE. Otherwise, if the timeline requirement is not satisfied this is an error case.

If a UE would transmit a first type 1 CG-PUSCH that includes UEI (CSI/beam) reports according to or following those specified/defined herein in the present disclosure (the first type 1 CG-PUSCH could be configured by configuredPUSCHResourceOjModeB-r19 in the same CC as the corresponding CSI-ReportConfig, which is the first available transmission occasion numOfSymbols-ModeB-r19 symbols after the end of the (transmitted) PUCCH that carries or conveys a/the UEIRI or UEIR-I if reportTransmissionMode-r19 is configured as ‘ModeB’) and a second PUSCH that includes an UL-SCH on the same carrier, and the first type 1 CG-PUSCH transmission would overlap in time with the second PUSCH transmission, the UE does not transmit the first type 1 PUSCH and transmits the second PUSCH. The UE expects that the first type 1 CG-PUSCH and second PUSCH transmissions satisfy the above timing conditions for PUSCH transmissions that overlap in time when at least one of the first type 1 CG-PUSCH or second PUSCH transmissions is in response to a DCI format detection by the UE.

In the present disclosure, a CSI processing unit (CPU) is provided.

The UE indicates the number of supported simultaneous CSI calculations N_{CPU} with parameter simultaneousCSI-ReportsPerCC or simultaneousCSI-SubReportsPerCC-r18 in a component carrier, and simultaneousCSI-ReportsAllCC or simultaneousCSI-SubReportsAllCC-r18 across all component carriers. If a UE supports N_{CPU} simultaneous CSI calculations it is said to have N_{CPU} CSI processing units (CPUs) for processing CSI reports. If L CPUs are occupied for calculation of CSI reports in a given OFDM symbol, the UE has N_{CRU}− L unoccupied CPUs. If N CSI reports start occupying their respective CPUs on the same OFDM symbol on which N_{CPU}-L CPUs are unoccupied, where each CSI report n=0, . . . , N−1 corresponds to

$${O}_{CPU}^{( n )} ,$$

the UE is not required to update the N—M requested CSI reports with lowest priority (according to Clause 5.2.5 of REF 4 and/or those specified/defined herein in the present disclosure), where 0≤M≤N is the largest value such that

$${\sum }_{n = 0}^{M - 1} {O}_{C P U}^{( n )} \leq {N}_{C P U} - L$$

holds.

A UE is not expected to be configured with an aperiodic CSI trigger state containing more than N_{CPU} Reporting Settings. Processing of a CSI report occupies a number of CPUs for a number of symbols as follows:
O_{CPU}=0 for a CSI report with CSI-ReportConfig with higher layer parameter reportQuantity set to ‘none’ and CSI-RS-ResourceSet with higher layer parameter trs-Info configured
O_{CPU}=1 for a CSI report with LTM-CSI-ReportConfig or a CSI report with CSI-ReportConfig with higher layer parameter reportQuantity set to ‘cri-RSRP’, ‘ssb-Index-RSRP’, ‘cri-SINR’, ‘ssb-Index-SINR’, ‘cri-RSRP-Index’, ‘ssb-Index-RSRP-Index’, ‘cri-SINR-Index’, ‘ssb-Index-SINR-Index’ or ‘none’ (and CSI-RS-ResourceSetwith higher layer parameter trs-Info not configured)
O_{CPU}=1 for an UEI CSI/beam report or a CSI report with CSI-ReportConfig with the higher layer parameter eventType-r19 set to ‘event1’, ‘event2’ or ‘event7’ and/or the higher layer parameter reportTransmissionMode-r19 set to ‘ModeA’ or ‘ModeB’, and/or the higher layer parameter reportQuantity set to ‘cri-RSRP’, ‘ssb-Index-RSRP’, ‘cri-RSRP-Index’, ‘ssb-Index-RSRP-Index’, or ‘none’
   the newBeamResourceSet-r19 is a NZP-CSI-RS-ResourceSet configured with repetition (and the NZP-CSI-RS-ResourceSet with higher layer parameter trs-Info not configured); in this case, the UE could expect that the higher layer parameter reportQuantity in the CSI-ReportConfig is set to ‘cri-RSRP’, ‘cri-RSRP-Index’, or ‘none’
   the newBeamResourceSet-r19 is a CSI-SSB-ResourceSet; in this case, the UE could expect that the higher layer parameter reportQuantity in the CSI-ReportConfig is set to ‘ssb-Index-RSRP’, ‘ssb-Index-RSRP-Index’, or ‘none’
O_{CPU}=1 or 0 for determining L1-RSRP value for a transmission occasion of a first reference signal as specified/defined herein in the present disclosure and/or for determining L1-RSRP value for a transmission occasion of a second reference signal as specified/defined herein in the present disclosure and/or for determining/to determine an event instance and/or for determining/to determine an event (i.e., satisfying the event and/or event condition(s) as specified/defined herein in the present disclosure)—e.g., before or prior to a corresponding/respective/associated PUCCH (transmission) of PUCCH format 0 or format 1 in a PUCCH resource configured by PUCCHResource-r19 in the CSI-ReportConfig that could carry or convey an UEIRI or UEIR-I as specified/defined herein in the present disclosure—with the CSI-ReportConfig with the higher layer parameter eventType-r19 set to ‘event1’, ‘event2’ or ‘event7’ and/or the higher layer parameter reportTransmissionMode-r19 set to ‘ModeA’ or ‘ModeB’, and/or the higher layer parameter reportQuantity set to ‘cri-RSRP’, ‘ssb-Index-RSRP’, ‘cri-RSRP-Index’, ‘ssb-Index-RSRP-Index’, or ‘none’
O_{CPU}=(Y+1)·X, for a CSI report with CSI-ReportConfig with higher layer parameter reportQuantity set to ‘tdcp’ and with number of delays Y configured by higher layer parameter Y, where the value of X∈{1, 2} is reported by UE capability.
For a CSI report with CSI-ReportConfig with higher layer parameter reportQuantity set to ‘cri-RI-PMI-CQI’, ‘cri-RI-i1’, ‘cri-RI-i1-CQI’, ‘cri-RI-CQI’, or ‘cri-RI-LI-PMI-CQI’,
   if max{μ_{PDCCH}, μ_{CSI-RS}, μ_{UL}}≤3, and if a CSI report is aperiodically triggered without transmitting a PUSCH with either transport block or HARQ-ACK or both when L=0 CPUs are occupied, where the CSI corresponds to a single CSI with wideband frequency-granularity and to at most 4 CSI-RS ports in a single resource without CRI report and where codebookType is set to ‘typeI-SinglePanel’ or where reportQuantity is set to ‘cri-RI-CQI’, O_{CPU}=N_{CRU},
   if a CSI-ReportConfig is configured with codebookType set to ‘typeI-SinglePanel’ and the corresponding CSI-RS Resource Set for channel measurement is configured with two Resource Groups and N Resource Pairs, O_{CPU}=X·N+M, where X is the number of CPUs occupied by a pair of CMRs subject to mTRP-CSI-numCPU-r17 and M is defined in clause 5.2.1.4.2,
   if a CSI-ReportConfig contains a list of L sub-configurations provided by the higher layer parameter csi-ReportSubConfigToAddModList,

$${O}_{C P U} = {\sum }_{i = 1}^{L} {K}_{s}^{i}$$

for periodic CSI reporting, where

$${K}_{s}^{i}$$

is the total number of CSI-RS resources corresponding to the i-th sub-configuration.

$${O}_{C P U} = {\sum }_{i = 1}^{N} {K}_{s}^{i}$$

for aperiodic and semi-persistent CSI reporting, where

$${K}_{s}^{i}$$

is the total number of CSI-RS resources corresponding to the i-th sub-configuration, and where the i-th sub-configuration is from Nindicated sub-configurations out of L sub-configurations contained in a CSI-ReportConfig, where N≤L and N≥1.
if a CSI-ReportConfig is configured with the higher layer parameter reportQuantity set to ‘cri-RI-PMI-CQI’, codebookType set to ‘typeII-CJT-r18’ or ‘typeII-CJT-PortSelection-r18’ and the corresponding NZP-CSI-RS-ResourceSet for channel measurement is configured with 1<N_{TRP}≤4 resources, O_{CPU}=ceil(X·N_{TRP}), where X∈{1,1.5,2} is reported by UE capability indication,
if a CSI-ReportConfig is configured with the higher layer parameter reportQuantity set to ‘cri-RI-PMI-CQI’ and with codebookType set to ‘typeII-Doppler-r18’ or ‘typeII-Doppler-PortSelection-r18’,
   if the corresponding CSI-RS Resource Set for channel measurement is aperiodic and configured with K CSI-RS resources, O_{CPU}=8 for K=12 and O_{CPU}=Y₁·K for K<12, where Y₁ ∈{1, 2, 3} is reported by UE capability indication,
   if the corresponding CSI-RS Resource Set for channel measurement is periodic or semi-persistent and configured with a single CSI-RS resource, O_{CPU}=4 for N₄=1 and O_{CPU}=max(Y₂·N₄, 4) for N₄>1, where the value of N₄ is configured by the higher layer parameter N4, and Y₂ ∈{1, 2, 3} is reported by UE capability indication,
otherwise, O_{CPU}=Kₛ, where Kₛ is the number of CSI-RS resources in the CSI-RS resource set for channel measurement.

For a CSI report with CSI-ReportConfig with higher layer parameter reportQuantity not set to ‘none’, or a CSI report with LTM-CSI-ReportConfig, or a UEI (CSI/beam) report with CSI-ReportConfig with the higher layer parameter eventType-r19 set to ‘event1’, ‘event2’ or ‘event7’ and/or the higher layer parameter reportTransmissionMode-r19 set to ‘ModeA’ or ‘ModeB’, the CPU(s) are occupied for a number of OFDM symbols as follows:
A periodic or semi-persistent CSI report (excluding an initial semi-persistent CSI report on PUSCH after the PDCCH triggering the report and a semi-persistent CSI report on PUSCH configured with the higher layer parameter codebookType set to ‘typeII-Doppler-r18’ or ‘typeII-Doppler-PortSelection-r18’) occupies CPU(s) from the first symbol of the earliest one of each CSI-RS/CS-IM/SSB resource, or each CSI-RS/CSI-IM resource associated with all configured sub-configurations for periodic CSI report corresponding to a CSI-ReportConfig that contains a list of sub-configurations provided by csi-ReportSubConfigToAddModList, or each CSI-RS/CSI-IM resource associated with all activated/triggered sub-configurations for semi-persistent CSI report corresponding to a CSI-ReportConfig that contains a list of sub-configurations provided by csi-ReportSubConfigToAddModList, for channel or interference measurement, respective latest CSI-RS/CSI-IM/SSB occasion no later than the corresponding CSI reference resource, until the last symbol of the configured PUSCH/PUCCH carrying the report.
An aperiodic CSI report occupies CPU(s) from the first symbol after the PDCCH triggering the CSI report until the last symbol of the scheduled PUSCH carrying the report. When the PDCCH reception includes two PDCCH candidates from two respective search space sets, as described in clause 10.1 of [6, REF 3], for the purpose of determining the CPU occupation duration, the PDCCH candidate that ends later in time is used.
An initial semi-persistent CSI report on PUSCH after the PDCCH trigger occupies CPU(s) from the first symbol after the PDCCH until the last symbol of the scheduled PUSCH carrying the report. When the PDCCH reception includes two PDCCH candidates from two respective search space sets, as described in clause 10.1 of [6, REF 3], for the purpose of determining the CPU occupation duration, the PDCCH candidate that ends later in time is used.
A semi-persistent CSI report on PUSCH configured with the higher layer parameter codebookType set to ‘typeII-Doppler-r18’ or ‘typeII-Doppler-PortSelection-r18’ occupies CPU(s) from the first symbol of K_{P}-th latest consecutive periodic/semi-persistent CSI-RS occasions no later than CSI reference resource, until the last symbol of the PUSCH carrying the report, where the value of K_{P} ∈{1,2,4} is indicated by UE capability.
A UEI (CSI/beam) report on a PUSCH indicated by the DCI format 0_1/0_2 in a PDCCH reception after the end of (or in response to) the (transmitted) PUCCH that carries or conveys a/the UEIRI or UEIR-I if reportTransmissionMode-r19 is configured as ‘ModeA’ occupies CPU(s) based on one or more of:
   from the first symbol (denoted by symbol A) of the earliest one of each reference SSB/NZP CSI-RS resource for event evaluation(s) and/or channel measurement(s) as specified/defined herein in the present disclosure, respective latest SSB/NZP CSI-RS occasion no later than the corresponding CSI reference resource as specified/defined herein in the present disclosure, until the last symbol of the (indicated/scheduled) PUSCH carrying or conveying the UEI (CSI/beam) report
   from the first symbol (denoted by symbol B) of or after the PDCCH—after the end of (or in response to) the (transmitted) PUCCH that carries or conveys a/the UEIRI or UEIR-I—that indicates the PUSCH to carry or convey the UEI (CSI/beam) report until the last symbol of the (indicated/scheduled) PUSCH carrying or conveying the UEI (CSI/beam) report. When the PDCCH reception includes two PDCCH candidates from two respective search space sets, as described in clause 10.1 of [6, REF 3], for the purpose of determining the CPU occupation duration, the PDCCH candidate that ends later in time is used
   from the first symbol (denoted by symbol C) of or after the (transmitted) PUCCH of PUCCH format 0 or format 1 in the PUCCH resource configured by PUCCHResource-r19 in the CSI-ReportConfig that carries or conveys the UEIRI or UEIR-I until the last symbol of the (indicated/scheduled) PUSCH carrying or conveying the UEI (CSI/beam) report,
according to or following (1) fixed rule(s)/value(s) in system specification(s) and/or per RRC (re-)configuration—e.g., symbol A, symbol B and/or symbol C as specified/defined herein in the present disclosure that starts/ends earlier/earlies (or later/latest) in time between/among symbols A, B and C, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc.
A UEI (CSI/beam) report on a type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys a/the UEIRI or UEIR-I if reportTransmissionMode-r19 is configured as ‘ModeB’ occupies CPU(s) based on one or more of:
   from the first symbol (denoted by symbol a) of the earliest one of each reference SSB/NZP CSI-RS resource for event evaluation(s) and/or channel measurement(s) as specified/defined herein in the present disclosure, respective latest SSB/NZP CSI-RS occasion no later than the corresponding CSI reference resource as specified/defined herein in the present disclosure, until the last symbol of the type 1 CG-PUSCH carrying or conveying the UEI (CSI/beam) report
   from the first symbol (denoted by symbol b) of or after the (transmitted) PUCCH of PUCCH format 0 or format 1 in the PUCCH resource configured by PUCCHResource-r19 in the CSI-ReportConfig that carries or conveys the UEIRI or UEIR-I until the last symbol of the type 1 CG-PUSCH carrying or conveying the UEI (CSI/beam) report,
according to or following (1) fixed rule(s)/value(s) in system specification(s) and/or per RRC (re-)configuration—e.g., symbol a and/or symbol b as specified/defined herein in the present disclosure that starts/ends earlier/earlies (or later/latest) in time between/among symbols a and b, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc.

For an event evaluation (including, e.g., determining L1-RSRP(s) for transmission occasion(s) of a second reference signal and/or determining event instance(s)) with CSI-ReportConfig with the higher layer parameter eventType-r19 set to ‘event1’ and/or the higher layer parameter reportTransmissionMode-r19 set to ‘ModeA’ or ‘ModeB’, wherein the event evaluation could be specific, associated or corresponding to a PUCCH of PUCCH format 0 or format 1 in a PUCCH resource configured by PUCCHResource-r19 in the CSI-ReportConfig that could carry or convey an UEIRI or UEIR-I according to or following those specified/defined herein in the present disclosure, the CPU(s) are occupied for a number of OFDM symbols as follows: the event evaluation occupies CPU(s) from the first transmission occasion/symbol of a second reference signal after t—UEIRI_{PERIODICITY} or t—UEIRI_{PERIODICITY}-T_proc until t or t—T_proc,
for example, the event evaluation occupies CPU(s) from the first transmission occasion/symbol of a second reference signal after t—UEIRI_{PERIODICITY} until t
for another example, the event evaluation occupies CPU(s) from the first transmission occasion/symbol of a second reference signal after t-UEIRI_{PERIODICITY}-T_proc until t-T_proc,
wherein
t represents the start (e.g., the first symbol/slot/etc.) or end (e.g., the last symbol/slot/etc.) of the PUCCH of PUCCH format 0 or format 1 in the PUCCH resource configured by PUCCHResource-r19 in the CSI-ReportConfig that could carry or convey an UEIRI or UEIR-I
UEIRI_{PERIODICITY} in symbols or slots and an offset UEIRI_{OFFSET} in slots could be provided by periodicityAndOffset for a PUCCH transmission of PUCCH format 0 or format 1 in a PUCCH resource configured by PUCCHResource-r19 in the CSI-ReportConfig with UEIRI or UEIR-I. If UEIRI_{PERIODICITY} is larger than one slot, the UE determines a transmission occasion of a PUCCH with UEIRI or UEIR-I to be in a slot with number

$${n}_{s , f}^{μ}$$

[4, REF 1] in a frame with number n_{f} if

$$( {n}_{f} \cdot {N}_{slot}^{frame , μ} + {n}_{s , f}^{μ} - {UEIRI}_{OFFSET} ) mod {UEIRI}_{PERIODICITY} = 0.$$

If UEIRI_{PERIODICITY} is one slot, the UE expects that UEIRI_{OFFSET}=0 and every slot is a transmission occasion of a PUCCH with UEIRI or UEIR-I. If UEIRI_{PERIODICITY} is smaller than one slot, the UE determines a transmission occasion of a PUCCH with UEIRI/UEIR-I to start in a symbol with index l [4, REF 1] if (l−l₀ modUEIRI_{PERIODICITY})modUEIRI_{PERIODICITY}=0 where l₀ is the value of startingSymbolIndex.
the UE could determine the value(s) of T_proc (the time span/gap/period/offset that the UE requires to prepare the PUCCH) according to or based on or following: (1) fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s)—e.g., T_proc could be provided in the CSI-ReportConfig specific to PUCCH resource(s) configured by PUCCHResource-r19 in the CSI-ReportConfig, and/or (3) UE's autonomous determination/selection, which could be further sent or transmitted or indicated to the network via/by/in various UL channels/signals including CSI/beam report(s), UE's capability signaling(s) and/or etc.,
and/or until (e.g., when/if the higher layer parameter reportTransmissionMode-r19 set to ‘ModeA’)
the last (or first) symbol (denoted by symbol A′) of the earliest one of each reference SSB/NZP CSI-RS resource for event evaluation(s) and/or channel measurement(s) as specified/defined herein in the present disclosure, respective latest SSB/NZP CSI-RS occasion no later than the corresponding CSI reference resource as specified/defined herein in the present disclosure, and/or
the last (or first) symbol (denoted by symbol B′) of or after the PDCCH—after the end of (or in response to) the (transmitted) PUCCH that carries or conveys a/the UEIRI or UEIR-I—that indicates the PUSCH to carry or convey the UEI (CSI/beam) report—when the PDCCH reception includes two PDCCH candidates from two respective search space sets, as described in clause 10.1 of [6, REF 3], for the purpose of determining the CPU occupation duration, the PDCCH candidate that ends later in time is used—and/or
the last (or first) symbol (denoted by symbol C′) of or after the (transmitted) PUCCH of PUCCH format 0 or format 1 in the PUCCH resource configured by PUCCHResource-r19 in the CSI-ReportConfig that carries or conveys the UEIRI or UEIR-I,
according to or following (1) fixed rule(s)/value(s) in system specification(s) and/or per RRC (re-)configuration—e.g., symbol A′, symbol B′ and/or symbol C′ as specified/defined herein in the present disclosure that starts/ends later/latest (or earlier/earlies) in time between/among symbols A′, B′ and C′, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc., and/or until (e.g., when/if the higher layer parameter reportTransmissionMode-r19 set to ‘ModeB’)
the last (or first) symbol (denoted by symbol a′) of the earliest one of each reference SSB/NZP CSI-RS resource for event evaluation(s) and/or channel measurement(s) as specified/defined herein in the present disclosure, respective latest SSB/NZP CSI-RS occasion no later than the corresponding CSI reference resource as specified/defined herein in the present disclosure, and/or
the last (or first) symbol (denoted by symbol b′) of or after the (transmitted) PUCCH of PUCCH format 0 or format 1 in the PUCCH resource configured by PUCCHResource-r19 in the CSI-ReportConfig that carries or conveys the UEIRI or UEIR-I,
according to or following (1) fixed rule(s)/value(s) in system specification(s) and/or per RRC (re-)configuration—e.g., symbol a′ and/or symbol b′ as specified/defined herein in the present disclosure that starts/ends later/latest (or earlier/earlies) in time between/among symbols a′ and b′, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc.

For an event evaluation (including, e.g., determining L1-RSRP(s) for transmission occasion(s) of a first reference signal and/or a second reference signal and/or determining event instance(s)) with CSI-ReportConfig with the higher layer parameter eventType-r19 set to ‘event2’ or ‘event7’ and/or the higher layer parameter reportTransmissionMode-r19 set to ‘ModeA’ or ‘ModeB’, wherein the event evaluation could be specific, associated or corresponding to a PUCCH of PUCCH format 0 or format 1 in a PUCCH resource configured by PUCCHResource-r19 in the CSI-ReportConfig that could carry or convey an UEIRI or UEIR-I according to or following those specified/defined herein in the present disclosure, the CPU(s) are occupied for a number of OFDM symbols as follows: the event evaluation occupies CPU(s) from the earliest or latest (in time) of/between the first transmission occasion/symbol of a first reference signal and the first transmission occasion/symbol of a second reference signal after t−UEIRI_{PERIODICITY} or t−UEIRI_{PERIODICITY}−T_proc until t or t−T_proc,
for example, the event evaluation occupies CPU(s) from the earliest or latest (in time) of/between the first transmission occasion/symbol of a first reference signal and the first transmission occasion/symbol of a second reference signal after t−UEIRI_{PERIODICITY} until t
for another example, the event evaluation occupies CPU(s) from the earliest or latest (in time) of/between the first transmission occasion/symbol of a first reference signal and the first transmission occasion/symbol of a second reference signal after t—UEIRI_{PERIODICITY}-T_proc until t−T_proc,
wherein
t represents the start (e.g., the first symbol/slot/etc.) or end (e.g., the last symbol/slot/etc.) of the PUCCH of PUCCH format 0 or format 1 in the PUCCH resource configured by PUCCHResource-r19 in the CSI-ReportConfig that could carry or convey an UEIRI or UEIR-I
UEIRI_{PERIODICITY} in symbols or slots and an offset UEIRI_{OFFSET} in slots could be provided by periodicityAndOffset for a PUCCH transmission of PUCCH format 0 or format 1 in a PUCCH resource configured by PUCCHResource-r19 in the CSI-ReportConfig with UEIRI or UEIR-I. If UEIRI_{PERIODICITY} is larger than one slot, the UE determines a transmission occasion of a PUCCH with UEIRI or UEIR-I to be in a slot with number

$${n}_{s , f}^{μ}$$

[4, REF 1] in a frame with number n_{f} if

$$( {n}_{f} \cdot {N}_{slot}^{frame , μ} + {n}_{s , f}^{μ} - {UEIRI}_{OFFSET} ) mod {UEIRI}_{PERIODICITY} = 0.$$

$$If {UEIRI}_{PERIODICITY}$$

is one slot, the UE expects that UEIRI_{OFFSET}=0 and every slot is a transmission occasion of a PUCCH with UEIRI or UEIR-I. If UEIRI_{PERIODICITY} is smaller than one slot, the UE determines a transmission occasion of a PUCCH with UEIRI/UEIR-I to start in a symbol with index l [4, REF 1] if (l−l₀ modUEIRI_{PERIODICITY})modUEIRI_{PERIODICITY}=0 where l₀ is the value of startingSymbolIndex.
The UE could determine the value(s) of T_proc (the time span/gap/period/offset that the UE requires to prepare the PUCCH) according to or based on or following: (1) fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s)—e.g., T_proc could be provided in the CSI-ReportConfig specific to PUCCH resource(s) configured by PUCCHResource-r19 in the CSI-ReportConfig, and/or (3) UE's autonomous determination/selection, which could be further sent or transmitted or indicated to the network via/by/in various UL channels/signals including CSI/beam report(s), UE's capability signaling(s) and/or etc.
and/or until (e.g., when/if the higher layer parameter reportTransmissionMode-r19 set to ‘ModeA’)
the last (or first) symbol (denoted by symbol A′) of the earliest one of each reference SSB/NZP CSI-RS resource for event evaluation(s) and/or channel measurement(s) as specified/defined herein in the present disclosure, respective latest SSB/NZP CSI-RS occasion no later than the corresponding CSI reference resource as specified/defined herein in the present disclosure, and/or
the last (or first) symbol (denoted by symbol B′) of or after the PDCCH—after the end of (or in response to) the (transmitted) PUCCH that carries or conveys a/the UEIRI or UEIR-I—that indicates the PUSCH to carry or convey the UEI (CSI/beam) report—when the PDCCH reception includes two PDCCH candidates from two respective search space sets, as described in clause 10.1 of [6, REF 3], for the purpose of determining the CPU occupation duration, the PDCCH candidate that ends later in time is used—and/or
the last (or first) symbol (denoted by symbol C′) of or after the (transmitted) PUCCH of PUCCH format 0 or format 1 in the PUCCH resource configured by PUCCHResource-r19 in the CSI-ReportConfig that carries or conveys the UEIRI or UEIR-I,
according to or following (1) fixed rule(s)/value(s) in system specification(s) and/or per RRC (re-)configuration—e.g., symbol A′, symbol B′ and/or symbol C′ as specified/defined herein in the present disclosure that starts/ends later/latest (or earlier/earlies) in time between/among symbols A′, B′ and C′, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc., and/or until (e.g., when/if the higher layer parameter reportTransmissionMode-r19 set to ‘ModeB’)
the last (or first) symbol (denoted by symbol a′) of the earliest one of each reference SSB/NZP CSI-RS resource for event evaluation(s) and/or channel measurement(s) as specified/defined herein in the present disclosure, respective latest SSB/NZP CSI-RS occasion no later than the corresponding CSI reference resource as specified/defined herein in the present disclosure, and/or
the last (or first) symbol (denoted by symbol b′) of or after the (transmitted) PUCCH of PUCCH format 0 or format 1 in the PUCCH resource configured by PUCCHResource-r19 in the CSI-ReportConfig that carries or conveys the UEIRI or UEIR-I, according to or following (1) fixed rule(s)/value(s) in system specification(s) and/or per RRC (re-)configuration—e.g., symbol a′ and/or symbol b′ as specified/defined herein in the present disclosure that starts/ends later/latest (or earlier/earlies) in time between/among symbols a′ and b′, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc.

According to or following those specified/defined herein in the present disclosure, the UE could expect that CPUs are occupied for both event evaluation and calculation of UEI (CSI/beam) report(s) with CSI-ReportConfig with the higher layer parameter eventType-r19 set to ‘event1’, ‘event2’ or ‘event7’ and/or the higher layer parameter reportTransmissionMode-r19 set to ‘ModeA’ or ‘ModeB’ in a given OFDM symbol, e.g., when/if a CSI reference resource, specific or associated or corresponding to a PUCCH of PUCCH format 0 or format 1 in a PUCCH resource configured by PUCCHResource-r19 in the CSI-ReportConfig that could carry or convey an UEIRI or UEIR-I according to or following those specified/defined herein in the present disclosure, wherein the start (e.g., the first symbol/slot/etc.) or end (e.g., the last symbol/slot/etc.) of the PUCCH/PUCCH resource is at t, is in a/the slot that starts or ends before or prior to t—T_proc, wherein the UE could determine the value(s) of T_proc (the time span/gap/period/offset that the UE requires to prepare the PUCCH) according to or based on or following: (1) fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s)—e.g., T_proc could be provided in the CSI-ReportConfig specific to PUCCH resource(s) configured by PUCCHResource-r19 in the CSI-ReportConfig, and/or (3) UE's autonomous determination/selection, which could be further sent or transmitted or indicated to the network via/by/in various UL channels/signals including CSI/beam report(s), UE's capability signaling(s) and/or etc.

According to or following those specified/defined herein in the present disclosure, for a UE configured or provided with CSI-ReportConfig with the higher layer parameter eventType-r19 set to ‘event1’ and/or the higher layer parameter reportTransmissionMode-r19 set to ‘ModeA’ or ‘ModeB’, the CPU(s) occupied for at least an event evaluation and calculation of UEI (CSI/beam) report(s) with the CSI-ReportConfig could start from:
the symbol(s) A, B and/or C as specified/defined herein in the present disclosure when/if reportTransmissionMode-r19 is configured as ‘ModeA’, and/or
the symbol(s) a and/or b as specified/defined herein in the present disclosure when/if reportTransmissionMode-r19 is configured as ‘ModeB’, and/or
the first transmission occasion/symbol of a second reference signal after t-UEIRI_{PERIODICITY} or t−UEIRI_{PERIODICITY}−T_proc, wherein the event evaluation could be specific, associated or corresponding to a PUCCH of PUCCH format 0 or format 1 in a PUCCH resource configured by PUCCHResource-r19 in the CSI-ReportConfig that could carry or convey an UEIRI or UEIR-I according to or following those specified/defined herein in the present disclosure, and
   t represents the start (e.g., the first symbol/slot/etc.) or end (e.g., the last symbol/slot/etc.) of the PUCCH of PUCCH format 0 or format 1 in the PUCCH resource configured by PUCCHResource-r19 in the CSI-ReportConfig that could carry or convey an UEIRI or UEIR-I
   UEIRI_{PERIODICITY} in symbols or slots and an offset UEIRI_{OFFSET} in slots could be provided by periodicityAndOffset for a PUCCH transmission of PUCCH format 0 or format 1 in a PUCCH resource configured by PUCCHResource-r19 in the CSI-ReportConfig with UEIRI or UEIR-I. If UEIRI_{PERIODICITY} is larger than one slot, the UE determines a transmission occasion of a PUCCH with UEIRI or UEIR-I to be in a slot with number n f [4, REF 1] in a frame with number f if

$$( {n}_{f} \cdot {N}_{slot}^{frame , μ} + {n}_{s , f}^{μ} - {UEIRI}_{OFFSET} ) mod {UEIRI}_{PERIODICITY} = 0.$$

If UEIRI_{PERIODICITY} is one slot, the UE expects that UEIRI_{OFFSET}=0 and every slot is a transmission occasion of a PUCCH with UEIRI or UEIR-I. If UEIRI_{PERIODICITY} is smaller than one slot, the UE determines a transmission occasion of a PUCCH with UEIRI/UEIR-I to start in a symbol with index l [4, REF 1] if (l−l₀ modUEIRI_{PERIODICITY})modUEIRI_{PERIODICITY}=0 where l₀ is the value of startingSymbolIndex.
the UE could determine the value(s) of T_proc (the time span/gap/period/offset that the UE requires to prepare the PUCCH) according to or based on or following: (1) fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s)—e.g., T_proc could be provided in the CSI-ReportConfig specific to PUCCH resource(s) configured by PUCCHResource-r19 in the CSI-ReportConfig, and/or (3) UE's autonomous determination/selection, which could be further sent or transmitted or indicated to the network via/by/in various UL channels/signals including CSI/beam report(s), UE's capability signaling(s) and/or etc.,
until
the symbol(s) A′, B′ and/or C′ as specified/defined herein in the present disclosure when/if reportTransmissionMode-r19 is configured as ‘ModeA’, and/or
the symbol(s) a′ and/or b′ as specified/defined herein in the present disclosure when/if reportTransmissionMode-r19 is configured as ‘ModeB’, and/or
the first (or last) symbol/slot/etc. of time instance t—T_proc, and/or
the first (or last) symbol/slot/etc. of the PUCCH/PUCCH resource, e.g., when/if the PUCCH is not transmitted (e.g., the event evaluation specific, corresponding or associated to the PUCCH/PUCCH resource results in that the corresponding event condition(s) are not satisfied hence the corresponding event cannot be determined), and/or
the first (or last) symbol/slot/etc. of time instance t+k, wherein: (1) for instance, the PUCCH is transmitted (e.g., the event evaluation specific, corresponding or associated to the PUCCH/PUCCH resource results in that the corresponding event condition(s) are satisfied hence the corresponding event is determined), and/or (2) the higher layer parameter reportTransmissionMode-r19 set to ‘ModeA’, and/or (3) the UE could expect to receive the DCI format 0_1/0_2 in a PDCCH reception after the end of the transmitted PUCCH at t and before t+k, wherein the UE could determine or identify the value(s) of k according to or based on or following: (1)fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc., and/or
the first (or last) symbol/slot/etc. of the PUSCH indicated by the DCI format 0_1/0_2 in a PDCCH reception after the end of the transmitted PUCCH that would carry or convey the UEI (CSI/beam) report when/if the higher layer parameter reportTransmissionMode-r19 is set to/configured as ‘ModeA’, and/or
the first (or last) symbol/slot/etc. of the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the transmitted PUCCH that that would carry or convey the UEI (CSI/beam) report when/if the higher layer parameter reportTransmissionMode-r19 is set to/configured as ‘ModeB’.

In one example, for a UE configured or provided with CSI-ReportConfig with the higher layer parameter eventType-r19 set to ‘event1’ and/or the higher layer parameter reportTransmissionMode-r19 set to ‘ModeA’ or ‘ModeB’, the CPU(s) occupied for at least an event evaluation and calculation of UEI (CSI/beam) report(s) with the CSI-ReportConfig—e.g., before or prior to a PUCCH (transmission) of PUCCH format 0 or format 1 in a PUCCH resource configured by PUCCHResource-r19 in the CSI-ReportConfig that could carry or convey an UEIRI or UEIR-I according to or following those specified/defined herein in the present disclosure—could comprise, include or contain two parts (part-1 occupied CPU(s) and part-2 occupied CPU(s)). In this example, the part-1 occupied CPU(s) could:
start from the first transmission occasion/symbol of a second reference signal after t-UEIRI_{PERIODICITY}-T_proc, wherein the event evaluation could be specific, associated or corresponding to the PUCCH of PUCCH format 0 or format 1 in the PUCCH resource configured by PUCCHResource-r19 in the CSI-ReportConfig that could carry or convey an UEIRI or UEIR-I according to or following those specified/defined herein in the present disclosure, and t, UEIRI_{PERIODICITY} and T_proc are defined according to or following those specified herein in the present disclosure,
until the first (or last) symbol/slot/etc. of time instance t−T_proc.
   The part-2 occupied CPU(s) could
start from the symbol A as specified/defined herein in the present disclosure when/if reportTransmissionMode-r19 is configured as ‘ModeA’, or the symbol a as specified/defined herein in the present disclosure when/if reportTransmissionMode-r19 is configured as ‘ModeB’,
until the first (or last) symbol/slot/etc. of the PUSCH indicated by the DCI format 0_1/0_2 in a PDCCH reception after the end of the transmitted PUCCH that would carry or convey the UEI (CSI/beam) report when/if the higher layer parameter reportTransmissionMode-r19 is set to/configured as ‘ModeA’, or the first (or last) symbol/slot/etc. of the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the transmitted PUCCH that that would carry or convey the UEI (CSI/beam) report when/if the higher layer parameter reportTransmissionMode-r19 is set to/configured as ‘ModeB’.

The part-1 CPU(s) could be occupied for a number of first OFDM symbol(s), and part-2 CPU(s) could be occupied for a number of second OFDM symbol(s).
In one example, the first OFDM symbol(s) could be (fully or partially) overlapping with the second OFDM symbol(s)—e.g., when/if the slot of/for the CSI reference resource starts (or ends) earlier in time than the end of the event evaluation specific, associated or corresponding to the PUCCH/PUCCH resource as specified/defined herein in the present disclosure (in this example, corresponding to the first (or last) symbol/slot/etc. of the time instance t—T_proc)
In another example, the first OFDM symbol(s) may not be overlapping or non-overlapping with the second OFDM symbol(s) at all—e.g., when/if the slot of/for the CSI reference resource starts (or ends) later in time than the end of the event evaluation specific, associated or corresponding to the PUCCH/PUCCH resource as specified/defined herein in the present disclosure (in this example, corresponding to the first (or last) symbol/slot/etc. of the time instance t—T_proc).

According to or following those specified/defined herein in the present disclosure, for a UE configured or provided with CSI-ReportConfig with the higher layer parameter eventType-r19 set to ‘event2’ or ‘event7’ and/or the higher layer parameter reportTransmissionMode-r19 set to ‘ModeA’ or ‘ModeB’, the CPU(s) occupied for at least an event evaluation and calculation of UEI (CSI/beam) report(s) with the CSI-ReportConfig could start from:
the symbol(s) A, B and/or C as specified/defined herein in the present disclosure when/if reportTransmissionMode-r19 is configured as ‘ModeA’, and/or
the symbol(s) a and/or b as specified/defined herein in the present disclosure when/if reportTransmissionMode-r19 is configured as ‘ModeB’, and/or
the earliest or latest (in time) of/between the first transmission occasion/symbol of a first reference signal and the first transmission occasion/symbol of a second reference signal after t—UEIRI_{PERIODICITY} or t—UEIRI_{PERIODICITY}-T_proc, wherein the event evaluation could be specific, associated or corresponding to a PUCCH of PUCCH format 0 or format 1 in a PUCCH resource configured by PUCCHResource-r19 in the CSI-ReportConfig that could carry or convey an UEIRI or UEIR-I according to or following those specified/defined herein in the present disclosure, and
   t represents the start (e.g., the first symbol/slot/etc.) or end (e.g., the last symbol/slot/etc.) of the PUCCH of PUCCH format 0 or format 1 in the PUCCH resource configured by PUCCHResource-r19 in the CSI-ReportConfig that could carry or convey an UEIRI or UEIR-I
   UEIRI_{PERIODICITY} in symbols or slots and an offset UEIRI_{OFFSET} in slots could be provided by periodicityAndOffset for a PUCCH transmission of PUCCH format 0 or format 1 in a PUCCH resource configured by PUCCHResource-r19 in the CSI-ReportConfig with UEIRI or UEIR-I. If UEIRI_{PERIODICITY} is larger than one slot, the UE determines a transmission occasion of a PUCCH with UEIRI or UEIR-I to be in a slot with number

$${n}_{s , f}^{μ}$$

[4, REF 1] in a frame with number n_{f} if

$$( {n}_{f} \cdot {N}_{slot}^{frame , μ} + {n}_{s , f}^{μ} - {UEIRI}_{OFFSET} ) mod {UEIRI}_{PERIODICITY} = 0.$$

If UEIRI_{PERIODICITY} is one slot, the UE expects that UEIRI_{OFFSET}=0 and every slot is a transmission occasion of a PUCCH with UEIRI or UEIR-I. If UEIRI_{PERIODICITY} is smaller than one slot, the UE determines a transmission occasion of a PUCCH with UEIRI/UEIR-I to start in a symbol with index l [4, REF 1] if (l−l₀ modUEIRI_{PERIODICITY})modUEIRI_{PERIODICITY}=0 where l₀ is the value of startingSymbolIndex.
the UE could determine the value(s) of T_proc (the time span/gap/period/offset that the UE requires to prepare the PUCCH) according to or based on or following: (1) fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s)—e.g., T_proc could be provided in the CSI-ReportConfig specific to PUCCH resource(s) configured by PUCCHResource-r19 in the CSI-ReportConfig, and/or (3) UE's autonomous determination/selection, which could be further sent or transmitted or indicated to the network via/by/in various UL channels/signals including CSI/beam report(s), UE's capability signaling(s) and/or etc.,
until
   the first (or last) symbol/slot/etc. of time instance t—T_proc, and/or
   the first (or last) symbol/slot/etc. of the PUCCH/PUCCH resource, e.g., when/if the PUCCH is not transmitted (e.g., the event evaluation specific, corresponding or associated to the PUCCH/PUCCH resource results in that the corresponding event condition(s) are not satisfied hence the corresponding event cannot be determined), and/or
   the first (or last) symbol/slot/etc. of time instance t+k, wherein: (1) for instance, the PUCCH is transmitted (e.g., the event evaluation specific, corresponding or associated to the PUCCH/PUCCH resource results in that the corresponding event condition(s) are satisfied hence the corresponding event is determined), and/or (2) the higher layer parameter reportTransmissionMode-r19 set to ‘ModeA’, and/or (3) the UE could expect to receive the DCI format 0_1/0_2 in a PDCCH reception after the end of the transmitted PUCCH at t and before t+k, wherein the UE could determine or identify the value(s) of k according to or based on or following: (1)fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc., and/or
   the first (or last) symbol/slot/etc. of the PUSCH indicated by the DCI format 0_1/0_2 in a PDCCH reception after the end of the transmitted PUCCH that would carry or convey the UEI (CSI/beam) report when/if the higher layer parameter reportTransmissionMode-r19 is set to/configured as ‘ModeA’, and/or
   the first (or last) symbol/slot/etc. of the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the transmitted PUCCH that that would carry or convey the UEI (CSI/beam) report when/if the higher layer parameter reportTransmissionMode-r19 is set to/configured as ‘ModeB’.

In one example, for a UE configured or provided with CSI-ReportConfig with the higher layer parameter eventType-r19 set to ‘event2’ or ‘event7’ and/or the higher layer parameter reportTransmissionMode-r19 set to ‘ModeA’ or ‘ModeB’, the CPU(s) occupied for at least an event evaluation and calculation of UEI (CSI/beam) report(s) with the CSI-ReportConfig—e.g., before or prior to a PUCCH (transmission) of PUCCH format 0 or format 1 in a PUCCH resource configured by PUCCHResource-r19 in the CSI-ReportConfig that could carry or convey an UEIRI or UEIR-I according to or following those specified/defined herein in the present disclosure—could comprise, include or contain two parts (part-1 occupied CPU(s) and part-2 occupied CPU(s)). In this example, the part-1 occupied CPU(s) could:
start from the earliest or latest (in time) of/between the first transmission occasion/symbol of a first reference signal and the first transmission occasion/symbol of a second reference signal after t—UEIRI_{PERIODICITY}-T_proc, wherein the event evaluation could be specific, associated or corresponding to the PUCCH of PUCCH format 0 or format 1 in the PUCCH resource configured by PUCCHResource-r19 in the CSI-ReportConfig that could carry or convey an UEIRI or UEIR-I according to or following those specified/defined herein in the present disclosure, and t, UEIRI_{PERIODICITY} and T_proc are defined according to or following those specified herein in the present disclosure,
until the first (or last) symbol/slot/etc. of time instance t—T_proc.

The part-2 occupied CPU(s) could
start from the symbol A as specified/defined herein in the present disclosure when/if reportTransmissionMode-r19 is configured as ‘ModeA’, or the symbol a as specified/defined herein in the present disclosure when/if reportTransmissionMode-r19 is configured as ‘ModeB’,
until the first (or last) symbol/slot/etc. of the PUSCH indicated by the DCI format 0_1/0_2 in a PDCCH reception after the end of the transmitted PUCCH that would carry or convey the UEI (CSI/beam) report when/if the higher layer parameter reportTransmissionMode-r19 is set to/configured as ‘ModeA’, or the first (or last) symbol/slot/etc. of the type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the transmitted PUCCH that that would carry or convey the UEI (CSI/beam) report when/if the higher layer parameter reportTransmissionMode-r19 is set to/configured as ‘ModeB’.

The part-1 CPU(s) could be occupied for a number of first OFDM symbol(s), and part-2 CPU(s) could be occupied for a number of second OFDM symbol(s).
In one example, the first OFDM symbol(s) could be (fully or partially) overlapping with the second OFDM symbol(s)—e.g., when/if the slot of/for the CSI reference resource starts (or ends) earlier in time than the end of the event evaluation specific, associated or corresponding to the PUCCH/PUCCH resource as specified/defined herein in the present disclosure (in this example, corresponding to the first (or last) symbol/slot/etc. of the time instance t—T_proc)
In another example, the first OFDM symbol(s) may not be overlapping or non-overlapping with the second OFDM symbol(s) at all—e.g., when/if the slot of/for the CSI reference resource starts (or ends) later in time than the end of the event evaluation specific, associated or corresponding to the PUCCH/PUCCH resource as specified/defined herein in the present disclosure (in this example, corresponding to the first (or last) symbol/slot/etc. of the time instance t—T_proc).

According to or following those specified/defined herein in the present disclosure, for a UE configured or provided with CSI-ReportConfig with the higher layer parameter eventType-r19 set to ‘event1’, ‘event2’ or ‘event7’ and/or the higher layer parameter reportTransmissionMode-r19 set to ‘ModeB’, the UE could indicate to the network, e.g., via/in/by their capability signaling(s), their supported value(s) of numOfSymbols-ModeB-r19 and/or T_gap, wherein T_gap could correspond to one or more of:
a time offset starting from the end (or start) of a PUCCH of PUCCH format 0 or format 1 in the PUCCH resource configured by PUCCHResource-r19 in the CSI-ReportConfig with eventType-r19 to the start (or end) of a/the nearest (in time) type 1 CG-PUSCH configured by configuredPUSCHResourceOfModeB-r19 in the same CC as the corresponding CSI-ReportConfig that starts (or ends) later in time than the PUCCH
a time offset starting from the end (or start) of a type 1 CG-PUSCH configured by configuredPUSCHResourceOfModeB-r19 in the same CC as the corresponding CSI-ReportConfig to the start (or end) of a/the nearest (in time) PUCCH of PUCCH format 0 or format 1 in the PUCCH resource configured by PUCCHResource-r19 in the CSI-ReportConfig with eventType-r19 that starts (or ends) later in time than the type 1 CG-PUSCH
a (minimum or maximum) time offset between the end (or start) of a PUCCH of PUCCH format 0 or format 1 in the PUCCH resource configured by PUCCHResource-r19 in the CSI-ReportConfig with eventType-r19 and the start (or end) of a type 1 CG-PUSCH configured by configuredPUSCHResourceOfModeB-r19 in the same CC as the corresponding CSI-ReportConfig such that the PUCCH and the type 1 CG-PUSCH are adjacent in time.

In this case, the UE may not expect the configured value(s) of numOfSymbols-ModeB-r19 and/or T_gap to be less (or lower or smaller) than (or equal to) the time gap or offset or duration starting from/between the first (or last) symbol/slot/etc. of (i) the reference SSB/NZP CSI-RS for event evaluation(s) and/or channel measurement(s) and/or (ii) the CSI reference resource determined according to or following those specified/defined herein in the present disclosure to/and the first (or last) symbol/slot/etc. of a/the type 1 CG PUSCH configured by configuredPUSCHResourceOfModeB-r19 in the same CC as the corresponding CSI-ReportConfig, which is the first available transmission occasion numOfSymbols-ModeB-r19 symbols after the end of the (transmitted) PUCCH that carries or conveys the UEIRI or UEIR-I, wherein the (transmitted) PUCCH/PUCCH resource could be specific, associated or corresponding to the CSI reference resource according to or following those specified/defined herein in the present disclosure.

According to or following those specified/defined herein in the present disclosure, for a UE configured or provided with CSI-ReportConfig with the higher layer parameter eventType-r19 set to ‘event1’, ‘event2’ or ‘event7’ and/or the higher layer parameter reportTransmissionMode-r19 set to ‘ModeA’ or ‘ModeB’, the UE may not expect to occupy CPU(s) or have occupied CPU(s) or the UE may expect to have unoccupied CPU(s) or the CPU(s) could be unoccupied for a/the number of OFDM symbol(s)
at least start from the first (or last) symbol/slot/etc. of a (transmitted) PUCCH of PUCCH format 0 or format 1 in a PUCCH resource configured by PUCCHResource-r19 in the CSI-ReportConfig that carries or conveys a UEIRI or UEIR-I,
and ends at the first (or last) symbol/slot/etc. of
   a/the PUSCH indicated by the DCI format 0_1/0_2 in a PDCCH reception after the end of (or in response to) the (transmitted) PUCCH that carries or conveys the UEI (CSI/beam) report when/if the higher layer parameter reportTransmissionMode-r19 is set to/configured as ‘ModeA’, or
   a/the type 1 CG-PUSCH configured by configuredPUSCHResourceOjModeB-r19 in the same CC as the corresponding CSI-ReportConfig, which is the first available transmission occasion numOfSymbols-ModeB-r19 symbols after the end of the (transmitted) PUCCH that carries or conveys the UEI (CSI/beam) report when/if the higher layer parameter reportTransmissionMode-r19 is set to/configured as ‘ModeB’. In this case, the UE may or would not (need to) indicate to the network, e.g., via/in/by their capability signaling(s), their supported value(s) of numOfSymbols-ModeB-r19 and/or T_gap as specified/defined herein in the present disclosure, and/or the configured value(s) of numOfSymbols-ModeB-r19 and/or T_gap as specified/defined herein in the present disclosure may not be subject to or depending on a/the corresponding UE's capability(s) or capability signaling(s).

In the present disclosure, active CSI-RS resource counting is provided.

In any slot, the UE is not expected to have more active CSI-RS ports or active CSI-RS resources in active BWPs than reported as capability. NZP CSI-RS resource is active in a duration of time defined as follows. For periodic CSI-RS used for event evaluation(s), channel measurement(s) and/or etc. according to or following those specified/defined herein in the present disclosure, for a UE configured with CSI-ReportConfig with the higher layer parameter eventType-r19 set to ‘event1’, ‘event2’ or ‘event7’ and/or the higher layer parameter reportTransmissionMode-r19 set to ‘ModeA’, starting
when the periodic CSI-RS is configured by higher layer signaling, and/or
from at least T_0 symbol(s)/slot(s)/ms/etc. after the end of a first (transmitted) PUCCH of PUCCH format 0 or format 1 in a PUCCH resource configured by PUCCHResource-r19 in the CSI-ReportConfig that carries or conveys a UEIRI or UEIR-I, and/or
from at least T_1 symbol(s)/slot(s)/ms/etc. after the end of a first PDCCH—after the end of (or in response to) a corresponding (transmitted) PUCCH that carries or conveys an UEIRI or UEIR-I—that indicates a PUSCH to carry or convey a UEI (CSI/beam) report, and/or
from at least T_2 symbol(s)/slot(s)/ms/etc. after the end of a first PUSCH indicated or scheduled by a corresponding PDCCH after the end of (or in response to) a corresponding (transmitted) PUCCH that carries or conveys an UEIRI or UEIR-I that carries or conveys an UEI (CSI/beam) report(s) as specified/defined herein in the present disclosure,
according to or based on or following: (1) fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc., and ending
when the periodic CSI-RS configuration is released, and/or
at the end of a second (transmitted) PUCCH of PUCCH format 0 or format 1 in a PUCCH resource configured by PUCCHResource-r19 in the CSI-ReportConfig that carries or conveys an UEIRI or UEIR-I, and/or
at the end of a second PDCCH—after the end of (or in response to) a corresponding (transmitted) PUCCH that carries or conveys an UEIRI or UEIR-I—that indicates a PUSCH to carry or convey an UEI (CSI/beam) report, and/or
at the end of a second PUSCH indicated or scheduled by a corresponding PDCCH after the end of (or in response to) a corresponding (transmitted) PUCCH that carries or conveys an UEIRI or UEIR-I that carries or conveys an UEI (CSI/beam) report(s) as specified/defined herein in the present disclosure,
according to or based on or following: (1) fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc., and the UE could determine or identify value(s) of TO, T_1 and/or T_2 according to or based on or following: (1) fixed rule(s)/value(s) in system specification(s) and/or per RRC (re-)configuration, e.g., value(s) of zero(s)/0(s), (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc.

Herein, the second PUCCH could be the first transmitted (in time) PUCCH that carries or conveys an UEIRI or UEIR-I as specified/defined herein in the present disclosure after or later in time than
transmission of the first PUCCH or at least T_0 symbol(s)/slot(s)/ms/etc. after transmission of the first PUCCH; and/or
reception of the first PDCCH or at least T_1 symbol(s)/slot(s)/ms/etc. after reception of the first PDCCH; and/or
transmission of the first PUSCH or at least T_2 symbol(s)/slot(s)/ms/etc. after transmission of the first PUSCH.

Alternatively, the second PDCCH could be the first PDCCH received (in time) after the end of (or in response to) a corresponding (transmitted) PUCCH that carries or conveys an UEIRI or UEIR-I to indicate a PUSCH to carry or convey an UEI (CSI/beam) report(s) as specified/defined herein in the present disclosure after or later in time than
transmission of the first PUCCH or at least T_0 symbol(s)/slot(s)/ms/etc. after transmission of the first PUCCH; and/or
reception of the first PDCCH or at least T_1 symbol(s)/slot(s)/ms/etc. after reception of the first PDCCH; and/or
transmission of the first PUSCH or at least T_2 symbol(s)/slot(s)/ms/etc. after transmission of the first PUSCH.

Optionally, the second PUSCH could be the first transmitted (in time) PUSCH indicated or scheduled by a corresponding PDCCH after the end of (or in response to) a corresponding (transmitted) PUCCH that carries or conveys an UEIRI or UEIR-I that carries or conveys an UEI (CSI/beam) report(s) as specified/defined herein in the present disclosure after or later in time than
transmission of the first PUCCH or at least T_0 symbol(s)/slot(s)/ms/etc. after transmission of the first PUCCH; and/or
reception of the first PDCCH or at least T_1 symbol(s)/slot(s)/ms/etc. after reception of the first PDCCH; and/or
transmission of the first PUSCH or at least T_2 symbol(s)/slot(s)/ms/etc. after transmission of the first PUSCH.

In any slot, the UE is not expected to have more active CSI-RS ports or active CSI-RS resources in active BWPs than reported as capability. NZP CSI-RS resource is active in a duration of time defined as follows. For periodic CSI-RS used for event evaluation(s), channel measurement(s) and/or etc. according to or following those specified/defined herein in the present disclosure, for a UE configured with CSI-ReportConfig with the higher layer parameter eventType-r19 set to ‘event1’, ‘event2’ or ‘event7’ and/or the higher layer parameter reportTransmissionMode-r19 set to ‘ModeB’, starting
when the periodic CSI-RS is configured by higher layer signaling, and/or
from at least T_0′ symbol(s)/slot(s)/ms/etc. after the end of a first (transmitted) PUCCH of PUCCH format 0 or format 1 in a PUCCH resource configured by PUCCHResource-r19 in the CSI-ReportConfig that carries or conveys a UEIRI or UEIR-I, and/or
from at least T_1′ symbol(s)/slot(s)/ms/etc. after the end of a first a type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of a corresponding (transmitted) PUCCH that carries or conveys an UEIRI or UEIR-I that carries or conveys an UEI (CSI/beam) report,
according to or based on or following: (1) fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc., and ending
when the periodic CSI-RS configuration is released, and/or
at the end of a second (transmitted) PUCCH of PUCCH format 0 or format 1 in a PUCCH resource configured by PUCCHResource-r19 in the CSI-ReportConfig that carries or conveys an UEIRI or UEIR-I, and/or
at the end of a second type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of a corresponding (transmitted) PUCCH that carries or conveys an UEIRI or UEIR-I, that carries or conveys an UEI (CSI/beam) report,
according to or based on or following: (1) fixed rule(s)/value(s) in system specification(s) and/or per RRC (re-)configuration, (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc., and the UE could determine or identify value(s) of T_0′ and/or T_1′ according to or based on or following: (1) fixed rule(s)/value(s) in system specification(s) and/or per RRC (re-)configuration, e.g., value(s) of zero(s)/0(s), (2) network's configuration(s)/indication(s) e.g. via/by/in higher layer RRC signaling(s)/parameter(s) and/or MAC CE command(s) and/or dynamic DCI based L1 signaling(s) based on or according to corresponding UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc.

Herein, the second PUCCH could be the first transmitted (in time) PUCCH that carries or conveys an UEIRI or UEIR-I as specified/defined herein in the present disclosure after or later in time than
transmission of the first PUCCH or at least T_0′ symbol(s)/slot(s)/ms/etc. after transmission of the first PUCCH; and/or
transmission of the first type 1 CG-PUSCH or at least T_1′ symbol(s)/slot(s)/ms/etc. after transmission of the first type 1 CG-PUSCH.

Alternatively, the second type 1 CG-PUSCH could be the first transmitted (in time) type 1 CG-PUSCH configured by configuredPUSCHResourceOjModeB-r19 in the same CC as the corresponding CSI-ReportConfig, which is the first available transmission occasion numOfSymbols-ModeB-r19 symbols after the end of a corresponding (transmitted) PUCCH that carries or conveys an UEIRI or UEIR-I that carries or conveys and UEI (CSI/beam) report after or later in time than
transmission of the first PUCCH or at least T_0′ symbol(s)/slot(s)/ms/etc. after transmission of the first PUCCH; and/or
transmission of the first type 1 CG-PUSCH or at least T_1′ symbol(s)/slot(s)/ms/etc. after transmission of the first type 1 CG-PUSCH.

If a CSI-RS resource is referred N times by one or more CSI Reporting Settings not configured with higher layer parameter csi-ReportSubConfigToAddModList, the CSI-RS resource and the CSI-RS ports within the CSI-RS resource are counted Ntimes.

For a CSI-RS Resource Set for channel measurement configured with two Resource Groups and N Resource Pairs, if a CSI-RS resource is referred X times by one of the M CSI-RS resources, where M is defined in clause 5.2.1.4.2, and/or one or two Resource Pairs, the CSI-RS resource and the CSI-RS ports within the CSI-RS resource are counted X times.

For a CSI-ReportConfig containing a list of L sub-configuration(s) provided by higher layer parameter csi-ReportSubConfigToAddModList, if a CSI-RS resource is referred by M sub-configurations among N triggered sub-configurations for CSI reporting for aperiodic CSI-RS resource, or L configured sub-configurations for CSI reporting for periodic or semi-persistent CSI-RS resource, the CSI-RS resource is counted M times and the CSI-RS ports within the CSI-RS resource are counted

$$max ( {\sum }_{s = 1}^{M} {P}_{s} , P ) ,$$

where P is the number of ports configured by nrofPorts and Pₛ is the number of CSI-RS ports in s-th sub-configuration from M sub-configurations derived from the corresponding antenna port subset indicator portSubsetlndicator according to clause 5.2.1.4.2 if configured, otherwise Pₛ=P.

For a periodic or semi-persistent CSI-RS resource in a CSI-RS resource set for channel measurement linked to a CSI-ReportConfig configured with the higher layer parameter codebookType set to ‘typeII-Doppler-r18’ or ‘typeII-Doppler-PortSelection-r18’, the CSI-RS resource and the CSI-RS ports within the CSI-RS resource are counted Kₚ times, where the value of Kₚ∈{1,2,4} is indicated by UE capability.

Throughout the present disclosure, periodic CSI-RS/SSB used for event evaluation(s), channel measurement(s) and/or etc. could correspond to the reference signal(s) configured by the newBeamResourceSet-r19 (in a same CC of CSI-ReportConfig, or in the CC provided by carrier in the CSI-ReportConfig) and/or
for a UE configured with a CSI-ReportConfig with the higher layer parameter eventType-r19 set to ‘event1’ or ‘event2’,
   the reference signal(s) in the indicated TCI state (applied to the same CC of the reference signal configured by the newBeamResourceSet-r19, or to the CC indicated by CCoflndicatedTCI-r19 in the CSI-ReportConfig), if newBeamResourceSet-r19 is a NZP-CSI-RS-ResourceSet configured with repetition, else
   the SS/PBCH block(s) which is QCLed with the reference signal(s) in the indicated TCI state (applied to the same CC of the reference signal configured by the newBeamResourceSet-r19, or to the CC indicated by CCoflndicatedTCI-r19 in the CSI-ReportConfig), if newBeamResourceSet-r19 is a CSI-SSB-ResourceSet,
and/or
for a UE configured with a CSI-ReportConfig with the higher layer parameter eventType-r19 set to ‘event7’,
   the reference signal(s) with the valueOfQ-r19 highest L1-RSRP(s) out of the reference signals among the activated TCI states (applied to the same CC of CSI-ReportConfigCSI-ReportConfig, or to the CC indicated by CCoflndicatedTCI-r19 in the CSI-ReportConfig), if newBeamResourceSet-r19 is a NZP-CSI-RS-ResourceSet configured with repetition, else
   SS/PBCH block(s) corresponding to
      setting-I: the SS/PBCH block(s) with the valueOfQ-r19 highest L1-RSRP(s) out of the SS/PBCH blocks QCLed with the reference signals among the activated TCI states (applied to the same CC of CSI-ReportConfigCSI-ReportConfig, or to the CC indicated by CCoflndicatedTCI-r19 in the CSI-ReportConfig), if newBeamResourceSet-r19 is a CSI-SSB-ResourceSet.
      setting-II: the SS/PBCH block(s) QCLed with the reference signal(s) with the valueOfQ-r19 highest L1-RSRP(s) out of the reference signals among the activated TCI states (applied to the same CC of CSI-ReportConfigCSI-ReportConfig, or to the CC indicated by CCoflndicatedTCI-r19 in the CSI-ReportConfig), if newBeamResourceSet-r19 is a CSI-SSB-ResourceSet.
   The UE could follow setting-I and/or setting-II to identify/determine the SS/PBCH block(s) according to or following: (1) fixed rule(s)/value(s) in system specification(s) and/or per RRC (re-)configuration, e.g., following setting-I or setting-II, (2) network's configuration(s)/indication(s) e.g. via/by/in higher layer RRC signaling(s)/parameter(s) and/or MAC CE command(s) and/or dynamic DCI based L1 signaling(s) based on or according to UE's capability(s) or capability signaling(s), and/or (3) UE's autonomous determination/selection, which could be further sent or transmitted or indicated to the network via/by/in various UL channels/signals including CSI/beam report(s), UE's capability signaling(s) and/or etc. For instance, depending on or according to or based on a corresponding UE's capability or capability signaling, when/if the UE is configured with a/the CSI-ReportConfig with the higher layer parameter ssbDetermination set to ‘type-I’ or ‘setting-I’, the UE could follow those specified/defined in setting-I to identify/determine the SS/PBCH block(s); and/or when/if the UE is configured with a/the CSI-ReportConfig with the higher layer parameter ssbDetermination set to ‘type-II’ or ‘setting-II’, the UE could follow those specified/defined in setting-II to identify/determine the SS/PBCH block(s).

Throughout the present disclosure, a PN message/trigger (i.e., the 1-bit indication that triggers or initiates transmission of the corresponding UEI CSI/beam report hence the UEI report content(s)/quantity(s) comprsied therein) transmitted or sent on the PUCCH resource of PUCCH format 0 or format 1 configured by firstPUCCHResourceConfig-UEIBR-r19 in the CSI-ReportConfig as in Step-1 of Mode A/Mode B as specified/defined herein in the present disclosure could be equivalent to or represented/denoted by or referred to as an indication for UEI beam report (UEIBR) or UEI CSI report (UEICR) or a UEIBRI indication/indication (UEIBRI) or a UEICR indication/inidcator (UEICRI).

Throughout the present disclosure, the time span/gap/period/offset that the UE requires to prepare the PUCCH, i.e., T_proc, could be zero. Furthermore, the start (or end) of the slot of/for a CSI reference resource (or the slot in which the CSI reference resource is) is equivalent to or can be understood as or can be used in an exchangeable manner throughout the present disclosure with the first (or last) symbol of the earliest one of each reference SSB/NZP CSI-RS resource for event evaluation(s) and/or channel measurement(s) as specified/defined herein in the present disclosure, respective latest SSB/NZP CSI-RS occasion no later than the corresponding CSI reference resource as specified/defined herein in the present disclosure.

Throughout the present disclosure, a candidate beam is equivalent to a candidate new beam or a new beam, and a beam/“beam” reported in a UEI (beam) report or a CSI report or a beam report in general can also be referred to as or equivalent to a report content/quantity—including SSBRI/CRI, L1-RSRP/L1-SINR and/or etc.—corresponding/associated/specific to a beam reported in a UEI (beam) report or a CSI report or a beam report in general, and/or one or more report contents/quantities—including SSBRI(s)/CRI(s), L1-RSRP(s)/L1-SINR(s) and/or etc.—corresponding/associated/specific to a beam reported in a UEI (beam) report or a CSI report or a beam report in general, and/or a resource indicator such as a SSBRI or a CRI reported in a UEI (beam) report or a CSI report or a beam report in general, and/or a beam metric such as a L1-RSRP or a L1-SINR reported in a UEI (beam) report or a CSI report or a beam report in general. In addition, throughout the present disclosure, a reference signal (RS) could be equivalent to a RS resource, a RS resource index, a RS resource configuration index, a RS index and/or etc.

Throughout the present disclosure, a CSI/beam report can also be referred to as or equivalent to a UE-initiated (UEI) report of (report-)type (A), (report-)type (B) and/or (report-)type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 CG PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s). Throughout the present disclosure, a UE could be provided or indicated or configured or informed or instructed by the network, e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

Throughout the present disclosure, an indicated (joint/DL/UL) TCI state could correspond to or could be referred to as a (joint/DL/UL) TCI state provided/indicated in/by/via a cell switch command (CSC) for a PCI or a candidate cell via MAC CE signaling(s).

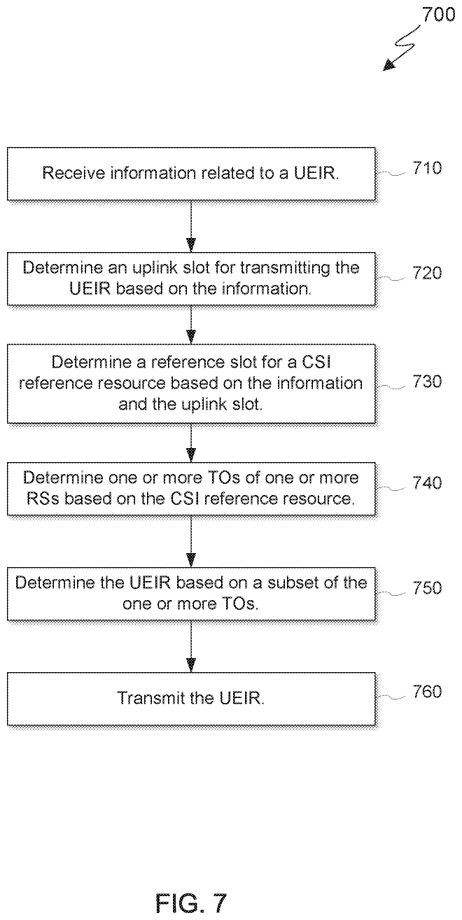

FIG. 7 illustrates an example method 700 performed by a UE in a wireless communication system according to embodiments of the present disclosure. The method 700 of FIG. 7 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 700 is for illustration only and other embodiments can be used without departing from the scope of the present disclosure.

The method 700 begins with the UE receiving information related to a UEIR (710). The UE then determines an uplink slot for transmitting the UEIR based on the information (720). The UE then determines a reference slot for a CSI reference resource based on the information and the uplink slot (730). For example, in 730, the information indicates a transmission mode. In various embodiments, the UE, when the transmission mode is set to ‘ModeA’, receives, in a downlink slot, a CSI request indicated by a DCI format in a PDCCH. In various embodiments, when the uplink slot is the same as the downlink slot, the UE determines that the reference slot is the same as the downlink slot. Otherwise, the UE determines determine that the reference slot is a smallest value greater than or equal to

$$⌊ \frac{{Z}^{′}}{{N}_{s y m b}^{s l o t}} ⌋ ,$$

where Z′ corresponds to a delay requirement and

$${N}_{symb}^{slot}$$

is a number of symbols in a slot. In various embodiments, reception of the PDCCH is after an end of transmission of a PUCCH that carries a UEIR indicator, and the information includes a configuration for transmission of the PUCCH. In various embodiments, when the transmission mode is set to ‘ModeB’, the UE determines that the reference slot is a smallest value greater than or equal to

$$⌊ \frac{{Z}^{′}}{{N}_{s y m b}^{s l o t}} ⌋ ,$$

where Z′ corresponds to a delay requirement and

$${N}_{s y m b}^{slot}$$

is a number of symbols in a slot.

The UE then determines one or more TOs of one or more RSs based on the CSI reference resource (740). In various embodiments, the one or more TOs are no later in time than the CSI reference resource or the subset of the one or more TOs are most recent among all TOs in the one or more TOs.

The UE then determines the UEIR based on a subset of the one or more TOs (750). For example, in 750, the one or more TOs are associated with determining an event or reporting measurements. In various embodiments, the UE determines whether a condition for the event is satisfied based on measurement of at least one RS corresponding to a TO in the subset or the UEIR includes at least one resource indicator identifying at least one RS corresponding to a TO in the subset. The at least one RS is associated with determining whether the condition for the event is satisfied. The UE then transmits the UEIR (760).

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive information related to a UE-initiated report (UEIR), wherein the information indicates a transmission mode; and
a processor operably coupled with the transceiver, the processor configured to:
determine, based on the information, an uplink slot for transmitting the UEIR;
determine, based on the information and the uplink slot, a reference slot for a channel state information (CSI) reference resource;
determine, based on the CSI reference resource, one or more transmission occasions (TOs) of one or more reference signals (RSs), wherein the one or more TOs are associated with determining an event or reporting measurements; and
determine the UEIR based on a subset of the one or more TOs,
wherein the transceiver is further configured to transmit the UEIR.

2. The UE of claim 1, wherein the transceiver is further configured to, when the transmission mode is set to ‘ModeA’, receive, in a downlink slot, a CSI request indicated by a downlink control information (DCI) format in a physical downlink control channel (PDCCH).

3. The UE of claim 2, wherein the processor is further configured to:
when the uplink slot is the same as the downlink slot, determine that the reference slot is the same as the downlink slot, and
otherwise, determine that the reference slot is a smallest value greater than or equal to
$$⌊ \frac{{Z}^{′}}{{N}_{s y m b}^{s l o t}} ⌋ ,$$
where Z′ corresponds to a delay requirement and
$${N}_{s y m b}^{slot}$$
is a number of symbols in a slot.

4. The UE of claim 2, wherein:
reception of the PDCCH is after an end of transmission of a physical uplink control channel (PUCCH) that carries a UEIR indicator, and
the information includes a configuration for transmission of the PUCCH.

5. The UE of claim 1, wherein the processor is further configured to, when the transmission mode is set to ‘ModeB’, determine that the reference slot is a smallest value greater than or equal to
$$⌊ \frac{{Z}^{′}}{{N}_{s y m b}^{s l o t}} ⌋ ,$$
where Z′ corresponds to a delay requirement and
$${N}_{s y m b}^{slot}$$
is a number of symbols in a slot.

6. The UE of claim 1, wherein:
the one or more TOs are no later in time than the CSI reference resource, or
the subset of the one or more TOs are most recent among all TOs in the one or more TOs.

7. The UE of claim 1, wherein:
the processor is further configured to determine whether a condition for the event is satisfied based on measurement of at least one RS corresponding to a TO in the subset, or
the UEIR includes at least one resource indicator identifying at least one RS corresponding to a TO in the subset, wherein the at least one RS is associated with determining whether the condition for the event is satisfied.

8. A base station (BS), comprising:
a transceiver configured to:
transmit information related to a user equipment initiated report (UEIR), wherein the information indicates a transmission mode; and
a processor operably coupled with the transceiver, the processor configured to:
determine, based on the information, an uplink slot for transmitting the UEIR;
determine, based on the information and the uplink slot, a reference slot for a channel state information (CSI) reference resource;
determine, based on the CSI reference resource, one or more transmission occasions (TOs) of one or more reference signals (RSs), wherein the one or more TOs are associated with determination of an event or reporting of measurements; and
determine the UEIR based on a subset of the one or more TOs,
wherein the transceiver is further configured to receive the UEIR.

9. The BS of claim 8, wherein the transceiver is further configured to, when the transmission mode is set to ‘ModeA’, transmit, in a downlink slot, a CSI request indicated by a downlink control information (DCI) format in a physical downlink control channel (PDCCH).

10. The BS of claim 9, wherein:
when the uplink slot is the same as the downlink slot, the reference slot is the same as the downlink slot, and
otherwise, the reference slot is a smallest value greater than or equal to
$$⌊ \frac{{Z}^{′}}{{N}_{s y m b}^{s l o t}} ⌋ ,$$
where Z′ corresponds to a delay requirement and
$${N}_{s y m b}^{slot}$$
is a number of symbols in a slot.

11. The BS of claim 9, wherein:
transmission of the PDCCH is after an end of reception of a physical uplink control channel (PUCCH) that carries a UEIR indicator, and
the information includes a configuration for reception of the PUCCH.

12. The BS of claim 8, wherein, when the transmission mode is set to ‘ModeB’, the reference slot is a smallest value greater than or equal to
$$⌊ \frac{{Z}^{′}}{{N}_{s y m b}^{s l o t}} ⌋ ,$$
where Z′ corresponds to a delay requirement and
$${N}_{s y m b}^{slot}$$
is a number of symbols in a slot.

13. The BS of claim 8, wherein:
the one or more TOs are no later in time than the CSI reference resource, or
the subset of the one or more TOs are most recent among all TOs in the one or more TOs.

14. The BS of claim 8, wherein:
whether a condition for the event is satisfied based on measurement of at least one RS corresponding to a TO in the subset, or
the UEIR includes at least one resource indicator identifying at least one RS corresponding to a TO in the subset, wherein the at least one RS is associated with whether the condition for the event is satisfied.

15. A method performed by a user equipment (UE), the method comprising:
receiving information related to a UE-initiated report (UEIR), wherein the information indicates a transmission mode;
determining, based on the information, an uplink slot for transmitting the UEIR;
determining, based on the information and the uplink slot, a reference slot for a channel state information (CSI) reference resource;
determining, based on the CSI reference resource, one or more transmission occasions (TOs) of one or more reference signals (RSs), wherein the one or more TOs are associated with determining an event or reporting measurements;
determining the UEIR based on a subset of the one or more TOs; and
transmitting the UEIR.

16. The method of claim 15, further comprising:
when the transmission mode is set to ‘ModeA’, receiving, in a downlink slot, a CSI request indicated by a downlink control information (DCI) format in a physical downlink control channel (PDCCH).

17. The method of claim 16, further comprising:
when the uplink slot is the same as the downlink slot, determining that the reference slot is the same as the downlink slot, and
otherwise, determining that the reference slot is a smallest value greater than or equal to
$$⌊ \frac{{Z}^{′}}{{N}_{s y m b}^{s l o t}} ⌋ ,$$
where Z′ corresponds to a delay requirement and
$${N}_{s y m b}^{slot}$$
is a number of symbols in a slot.

18. The method of claim 16, wherein:
reception of the PDCCH is after an end of transmission of a physical uplink control channel (PUCCH) that carries a UEIR indicator, and
the information includes a configuration for transmission of the PUCCH.

19. The method of claim 15, further comprising, when the transmission mode is set to ‘ModeB’, determining that the reference slot is a smallest value greater than or equal to
$$⌊ \frac{{Z}^{′}}{{N}_{s y m b}^{s l o t}} ⌋ ,$$
where Z′ corresponds to a delay requirement and
$${N}_{s y m b}^{slot}$$
is a number of symbols in a slot.

20. The method of claim 15, wherein:
the one or more TOs are no later in time than the CSI reference resource, or
the subset of the one or more TOs are most recent among all TOs in the one or more TOs.
